(19) United States
(12) Patent Application Publication
(10) Pub. No.: US 2026/0065750 A1
(43) Pub. Date: Mar. 5, 2026

(54) RANDOM REVEAL DYNAMIC SYMBOLS IN A GAMING ENVIRONMENT

(71) Applicant: Aristocrat Technologies, Inc., Las Vegas, NV (US)

(72) Inventors: Blake Davis, Las Vegas, NV (US); Allon Englman, Las Vegas, NV (US)

(21) Appl. No.: 19/229,293

(22) Filed: Jun. 5, 2025

Related U.S. Application Data
(60) Provisional application No. 63/689,279, filed on Aug. 30, 2024.

(51) Int. Cl. G07F 17/32; G07F 17/34

(52) U.S. Cl. CPC G07F 17/3267; G07F 17/34

(57) ABSTRACT

Systems and method for electronic gaming, including (i) performing a first lookup in a lookup table to determine a plurality of symbols for a designated play, including at least one reveal symbol, (ii) performing a second lookup to determine a dynamically selected common symbol for association with the at least one reveal symbol, (iii) causing display of the at least one reveal symbol for the designated play followed by display of the common symbol at a same position as the at least one reveal symbol, the display of the at least one reveal symbol being ceased upon the display of the dynamically selected symbol; and (iv) depending on a symbol type of the at least one reveal symbol, causing display of a subsequent at least one reveal symbol at a position on a reel set of a subsequent play that is the same as for the designated play.

### CROSS REFERENCE TO RELATED APPLICATIONS

This application claims the benefit of priority of U.S. Provisional Application No. 63/689,279, filed Aug. 30, 2024, titled “RANDOM REVEAL DYNAMIC SYMBOLS IN A GAMING ENVIRONMENT,” the contents and disclosures of which are hereby incorporated herein by reference in their entirety.

### TECHNICAL FIELD

The field of disclosure relates generally to electronic gaming, and more specifically, to electronic gaming systems and methods that include determining, managing, and displaying random reveal dynamic symbols during game play wherein the random reveal dynamic symbols are associated with one or more random chances to reveal a randomly determined, dynamically selected symbol associated with the random reveal dynamic symbols.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a feature game (e.g., including one or more free spins), a secondary game, or a bonus round of the base game by attaining a certain winning combination or triggering event in, or related to, the base game, or after the player is randomly awarded the special mode, secondary game, or bonus round. For example, in the special mode, feature game, secondary game, or bonus round, the player is given an opportunity to win free games (e.g., free spins), extra game credits, game tokens and/or other forms of payout. In the case of free games, additional free games may be added to an initial amount of free games won. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her/their wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Persistent (or “sticky,” used interchangeably with “persistent” herein) symbols operate uniquely in electronic slot games, where they adhere to the reels once they appear, remaining fixed in place for a predetermined number of spins or until particular conditions are met. This distinctive feature enhances the gameplay dynamics by increasing the likelihood of creating winning combinations over successive spins. Whether encountered during the base game or activated within bonus rounds such as free spins, the ability of sticky symbols to stay in play (e.g., persist) across multiple spins introduces additional processing and memory complexities for electronic games. There are several types of sticky symbols, including sticky wild symbols, multiplier sticky symbols, and random sticky symbols, described in more detail herein. In addition to sticky symbols, there are persistent (or “sticky”) reels which are features in slot games in which an entire reel locks in place for additional re-spins or during an entire bonus round.

Sticky wilds (also referred to herein as “locked wilds”) are a type of sticky symbol that is widely used in land-based and web-based (e.g., online) slot machine games. Sticky wilds assist in improving a game outcome by granting wild symbols on the reels which remain sticky during the re-spin or free spins bonus feature. Put another way, sticky wilds act as a standard wild and will substitute for any other symbol to create a winning line, but where they differ is that they will remain on the reel for subsequent spins. Sticky wilds are often found in free spin bonus rounds, where they will stay for the duration of the free spins and can generate huge extra wins as part of the bonus feature. This characteristic adds an element of anticipation and strategy to gameplay, as these sticky symbols can persist through multiple spins, potentially increasing the chances of forming winning combinations. Games incorporating the use of sticky wilds tend to be quite volatile, but produce fruitful winnings for a user in the bonuses and features. For example, high volatility means that while sticky wilds may not trigger often, when they do, it can lead to significant wins.

Multiplier sticky symbols not only adhere to the reels but also come with a built-in multiplier value. When included in a winning combination, multiplier sticky symbols multiply the payout by their designated multiplier factor.

Random sticky symbols are sticky symbols that may appear unpredictably during spins or as part of a randomly triggered special feature in certain slot games. These slot symbols provide additional game play aspects and elements, as their appearance is not tied to specific patterns or sequences. When they do appear, random sticky symbols typically stick to their positions on the reels for a limited number of spins, contributing to the potential formation of winning combinations. This random aspect of sticky symbols adds a dynamic dimension to the game, keeping players engaged and eager to see which symbols will stick next.

A “hold & spin” feature in slot games is another feature that adds a unique twist to traditional slot game play, and may be utilized in a bonus round or other special mode or other game. The hold & spin feature is typically activated by landing a specific combination of symbols on the reels, although individual symbols may have their own hold & spin characteristics. These symbols are detailed and their parameters set in the game's rules and/or paytable(s). Once triggered (e.g., via an RNG call), the (e.g., bonus) symbols that activated the feature are “held” in their positions on the reels. The remaining reels then spin again, giving the player a chance to land additional (e.g., bonus) symbols. A set number of re-spins may be awarded a set number of re-spins. If more (e.g., bonus) symbols land during these re-spins, they may also become held in place, and the re-spin counter may reset. The feature continues until the re-spins are exhausted or, for example, if all reel positions are filled with (e.g., bonus) symbols. The (e.g., bonus) symbols may display jackpot prizes or other award amounts, which are awarded at the end of the feature.

What is needed are advanced hardware and software configurations to accommodate advanced process controls for a complex game mechanic that is designed to determine and display a common symbol associated with a set of reveal symbols that operate to reveal the common symbol, where certain symbols of the set of reveal symbols implement a hold & spin type mechanic—the advanced hardware and software configuration being specifically designed to improve the accuracy, efficiency, and speed with which the process controls and game mechanic are implemented, accounting for the additional computational complexities resulting from such process controls and game mechanic aspects.

### BRIEF DESCRIPTION

In one embodiment, a system for electronic gaming including at least one memory device storing instructions and one or more lookup tables storing symbol data therein and at least one processor in communication with the at least one memory device. The instructions, when executed by the at least one processor, cause the at least one processor to perform a first lookup in the one or more lookup tables to determine a plurality of symbols for a designated play of an electronic game, the plurality of symbols including at least one reveal symbol located at a position on a reel of a reel set of the designated play of the electronic game. The instructions, when executed by the at least one processor, further cause the at least one processor to perform a second lookup in the one or more lookup tables to determine a common symbol for association with the at least one reveal symbol, the common symbol being a dynamically selected symbol from a set of the plurality of symbols excluding the at least one reveal symbol. The instructions, when executed by the at least one processor, yet further cause the at least one processor to cause display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol. The instructions, when executed by the at least one processor, yet further still cause the at least one processor to depending on a symbol type of the at least one reveal symbol, cause display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

In another embodiment, a computer-implemented method for electronic gaming, the computer-implemented method being performed by a system including at least one memory device storing instructions and one or more lookup tables storing symbol data therein and at least one processor in communication with the at least one memory device. The computer-implemented method includes performing a first lookup in the one or more lookup tables to determine a plurality of symbols for a designated play of an electronic game, the plurality of symbols including at least one reveal symbol located at a position on a reel of a reel set of the designated play of the electronic game. The computer-implemented method further includes performing a second lookup in the one or more lookup tables to determine a common symbol for association with the at least one reveal symbol, the common symbol being a dynamically selected symbol from a set of the plurality of symbols excluding the at least one reveal symbol. The computer-implemented method yet further includes causing display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol. The computer-implemented method yet further still includes: depending on a symbol type of the at least one reveal symbol, causing display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

In yet another embodiment, at least one non-transitory computer-readable media having computer-executable instructions stored thereon for electronic gaming. The computer-executable instructions, wherein when executed by a system comprising at least one memory device storing instructions and one or more lookup tables storing symbol data therein and at least one processor in communication with the at least one memory device, cause the at least one processor to perform a first lookup in the one or more lookup tables to determine a plurality of symbols for a designated play of an electronic game, the plurality of symbols including at least one reveal symbol located at a position on a reel of a reel set of the designated play of the electronic game. The computer-executable instructions, when executed, further cause the at least one processor to perform a second lookup in the one or more lookup tables to determine a common symbol for association with the at least one reveal symbol, the common symbol being a dynamically selected symbol from a set of the plurality of symbols excluding the at least one reveal symbol. The computer-executable instructions, when executed, yet further cause the at least one processor to cause display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol. The computer-executable instructions, when executed, yet further still cause the at least one processor to: depending on a symbol type of the at least one reveal symbol, cause display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A illustrates an example interface of a free game session of a base game of an electronic game according to one embodiment of the present disclosure.

FIG. 4B illustrates an example subsequent interface of the free game session shown in FIG. 4A according to one embodiment of the present disclosure.

FIG. 5A illustrates an example interface of a free game session of a base game of the electronic game according to one embodiment of the present disclosure.

FIG. 5B illustrates an example subsequent interface of the free game session shown in FIG. 5A according to one embodiment of the present disclosure.

FIG. 6A illustrates an example interface of a free game session of a base game of the electronic game according to one embodiment of the present disclosure.

FIG. 6B illustrates an example subsequent interface of the free game session shown in FIG. 6A according to one embodiment of the present disclosure.

FIG. 7 illustrates an example interface of a free game session of a base game of the electronic game according to one embodiment of the present disclosure.

FIG. 8 illustrates an example method for providing the electronic game shown in FIGS. 4A, 4B, 5A, 5B, 6A, 6B, and 7.

FIG. 9 illustrates, in block diagram form, a customized configuration of a game controller and a game processing architecture shown in FIGS. 2A and 3.

FIG. 10 illustrates a customized configuration of a lookup table shown in FIG. 3.

FIG. 11 illustrates an example method for providing the electronic game shown in FIGS. 4A, 4B, 5A, 5B, 6A, 6B, and 7 using the customized configurations shown in FIGS. 9 and 10.

### DETAILED DESCRIPTION

Described herein are electronic gaming systems and methods for process controls and game mechanics that leverage advanced data processing and/or memory management techniques to implement random reveal dynamic symbols including both random persistent and nonpersistent reveal dynamic symbols, as well as a common symbol associated therewith (that is, the random persistent and nonpersistent reveal dynamic symbols, in operation, reveal the same symbol, a “common symbol”). The random reveal dynamic symbols, in either the persistent or non-persistent form, may more generally be referred to herein as just “reveal symbols,” and function to increase randomness, and manifest as new game play elements to an electronic game, adding more nuanced game play complexity to the electronic game (which brings along more nuanced computing processing and memory management complexity).

The present disclosure describes a new game mechanic for “random reveal dynamic symbols” (or simply “reveal symbols”) that may be in the form of (i) “random persistent reveal dynamic symbols” (also referred to as “random sticky reveal dynamic symbols”) in the case of reveal symbols that are persistent (e.g., “sticky”) across spins and/or (ii) “random non-persistent reveal dynamic symbols” (also referred to as “random non-sticky reveal dynamic symbols”) in the case of reveal symbols that are not persistent (e.g., not “sticky”). This mechanic may be embodied in or as a free game's feature “hold & spin” as described herein. The execution of the random persistent reveal dynamic symbols game mechanic differs drastically from conventional persistent mechanics and the implementation of such a different mechanic introduces additional design complexity that requires specialized hardware and/or software configurations to achieve. For example, conventional persistent symbols may be randomly placed on reel strips and adhere to the reels for a certain number of spins once they appear. However, unlike conventional “sticky” symbols which replace certain symbol positions on the reel strip, the present disclosure incorporates the use of “sticky” symbols with other randomly determined and defined symbol positions which all share a common, randomly determined, dynamically selected symbol (e.g., “common symbol”), as described in more detail herein.

As described herein, each reel of an electronic reel-based game may be represented by a pre-programmed reel strip including a sequence of symbols arranged in a specific order that defines the odds and payout structure, configured to ensure that the game follows its designed probability distributions and/or other necessary regulations. However, to add layers of randomness and/or interactivity, dynamic symbols may be implemented, where such dynamic symbols may be part of a pool (e.g., a secondary pool) of symbols or as an overlay mechanism that allows certain symbols of a primary pool of symbols to appear conditionally. This secondary pool of dynamic symbols may not be fixed on the reel strip as compared to other (e.g., non-dynamic) symbols in the primary pool; instead, the dynamic symbols may operate in parallel to the symbols for the “standard” layout (e.g., standard (e.g., non-dynamic) symbols that are used to populate the reels and that land for corresponding plays/spins of the game), ready to be deployed when specific events occur.

More specifically, in a so-called “static” reel strip implementation, every symbol is bound to a specific index or block of positions on the “static” reel strip, where an output of an RNG call is directly mapped to one of these fixed positions. In contrast, dynamic symbol selection means that while a “static” digital reel strip may still be used as the foundation, the symbol (e.g., the “dynamic” symbol) that ultimately appears as part of the game outcome in a particular position is determined on the fly (e.g., dynamically”). Thus, compared to a so-called “static” digital reel strip that is associated with a predetermined list of symbols (each having a fixed position with specific weights or frequencies), and where the symbols are selected in accordance with a mapping to a given RNG value or range of values, dynamic symbol selection introduces an additional layer of decision-making. While the underlying reel strip may remain fixed in design, the game's logic can, at runtime, dynamically select a symbol rather than simply reading off a predetermined symbol from its absolute position. Put another way, the “final” symbol isn't always a mere read-off from a fixed reel strip; it can be the result of an additional, context-sensitive process that adjusts or overrides the predetermined outcomes. However, along with the use of dynamically selected symbols comes increased computational complexities.

The present disclosure advances the technology relating to dynamic and/or persistent symbols forward by utilizing advanced processing and/or memory management techniques to implement a new game mechanic for “random persistent reveal dynamic symbols” as described herein. The new game mechanic described herein stands apart from conventional persistent and/or dynamic symbol mechanics both in execution and implementation, as additional design complexity is necessary to achieve the new game mechanic. For example, conventional persistent symbols may be randomly placed on reel strips and adhere to the reels for a certain number of spins once they appear. However, unlike conventional persistent symbols which replace certain symbol positions on the reel strip, the “sticky” symbols described herein are incorporated for use with other randomly determined and defined symbol positions which all share a common randomly determined, dynamically selected symbol.

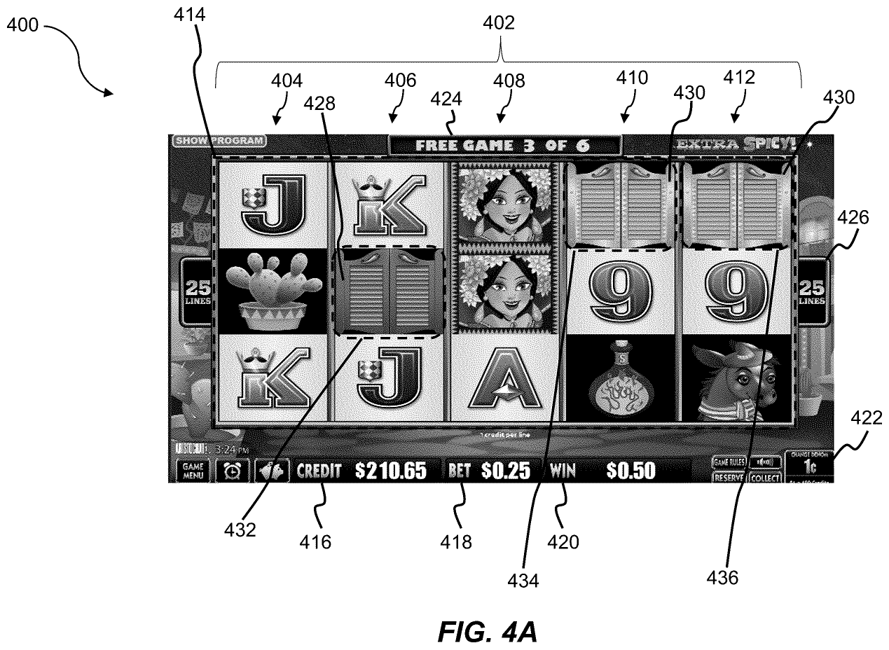

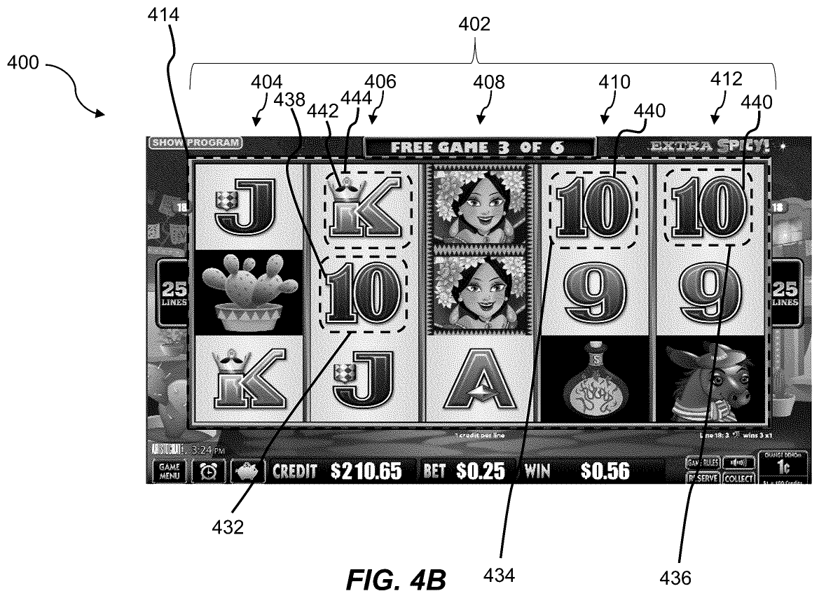

As described in more detail herein and in connection with the figures (e.g., FIGS. 4A, 4B, 5A, 5B, 6A, and 6B), in a free game scenario, for example, both non-persistent (e.g., “non-sticky,” used interchangeably with “non-persistent” herein) and persistent (e.g., “sticky”) symbols may randomly land and reveal a dynamically selected symbol that is common amongst the non-persistent and persistent symbols—that is, a dynamically selected symbol (e.g., the same dynamically selected symbol) is revealed in association with the landed persistent and non-persistent symbols. For example, when the reels come to a complete stop, both the non-sticky and sticky symbols operate to reveal the same dynamically selected symbol in each reel position corresponding to where the non-sticky and sticky symbols landed. After the dynamically-selected symbols corresponding to the non-sticky and sticky symbols have been revealed, play of the game may resume for additional (e.g., free) spins of the reels. In doing so, the symbol positions located at the non-sticky symbols will reset and revert to normal symbol positions once again, whereas the symbol positions located at the sticky symbol positions will stay on the reels for a certain duration, such as throughout the remaining free games (including, for example, if additional free games are won during play of an existing free game, thereby extending play of the free game). Once the subsequent free game reels have come to a stop, the symbol positions located at the sticky symbol positions will once again reveal a dynamically selected symbol (which may be different from prior dynamically selected symbols from prior free game spins). The dynamically-selected symbols may be symbols from a first pool of standard symbols of the game, but may also include special symbols such as “free game” symbols and the like.

More specifically, in a scenario where one or more random sticky and/or non-sticky reveal symbols land, a dedicated rule for activating dynamic symbol selection may trigger, and one or more RNG calls may be performed to determine the dynamic common symbol(s) that will be revealed upon each spin of the game outcome, via execution of a “reveal” operation of the random sticky and/or non-sticky reveal symbols (e.g., where the random sticky and/or non-sticky reveal symbols “reveal” the common symbol for the given spin/game instance). This may include a plurality of computational operations including the likes of event detection, specialized RNG calls, dynamic symbol integration, and/or updating the game state, as described herein in more detail.

For example, for event detection, when the game controller of the EGM identifies that one or more random persistent and/or non-persistent reveal dynamic symbols has landed, the game controller may flag the associated reel position and that a dynamic action should follow. This may include populating a corresponding table with a record of the landed persistent reveal symbols. At this point, the game controller may leverage RNG programs and/or algorithms to conduct an RNG call for purposes of selecting a candidate symbol from a pool of the persistent/non-persistent reveal symbols (e.g., a green saloon door symbol for the non-persistent reveal symbol or a gold saloon door symbol for the persistent reveal symbol, as described herein). This reveal symbol RNG call may be separate and apart from an RNG call relating to other base symbols and aspects of the game, such as an RNG call associated with a payout. The reveal symbol pool may be managed in a dedicated memory such as a high-speed memory cache so that the selection can be rapid and seamless, whereas symbol selection from a pool of standard population symbols may be associated with a different memory that may have a lesser priority. Similarly, a pool of symbols for selection as the dynamic common symbol may be implemented via separate memory/processing priority. Alternatively, even if the pools of symbols are stored in a same memory, data for the reveal symbol pool and/or the dynamic common symbol pool may be stored in dedicated data structures (e.g., tables, etc.) separate from non-reveal symbols to realize the processing and/or memory management improvements described herein.

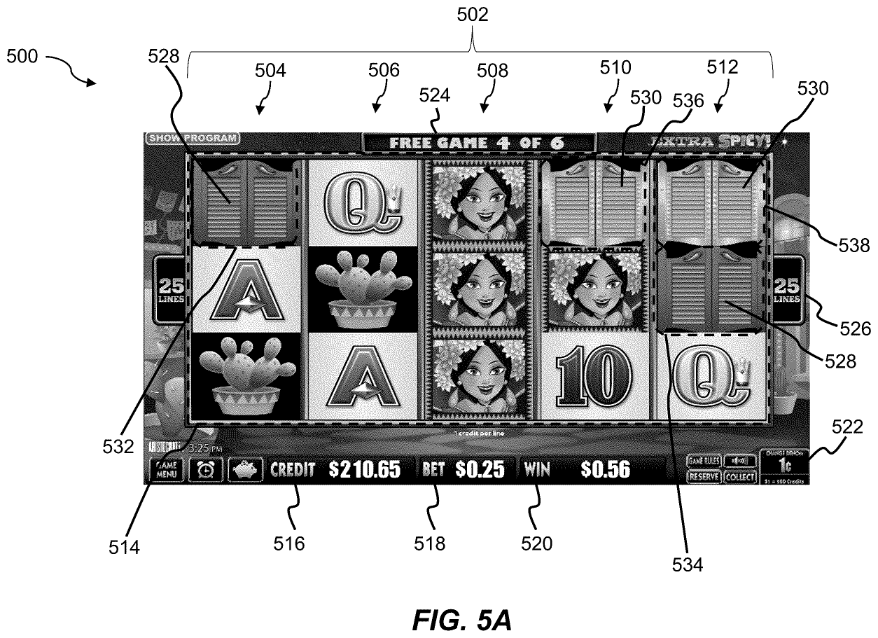

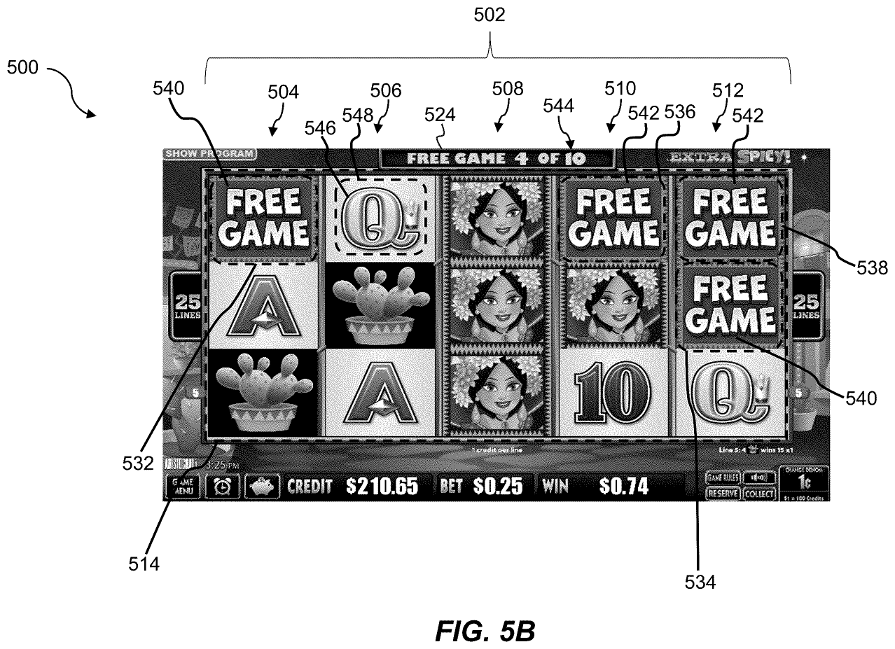

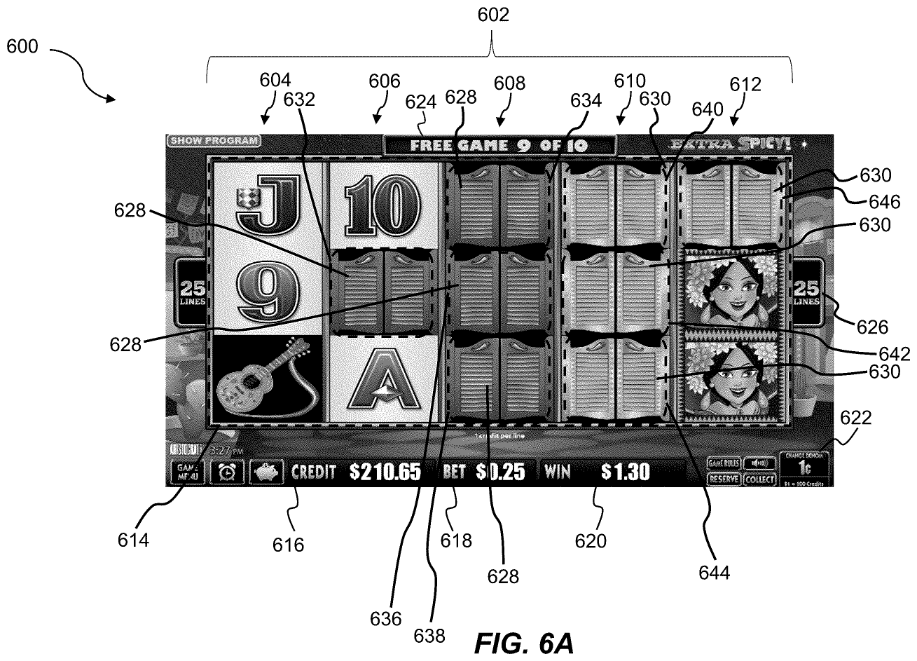

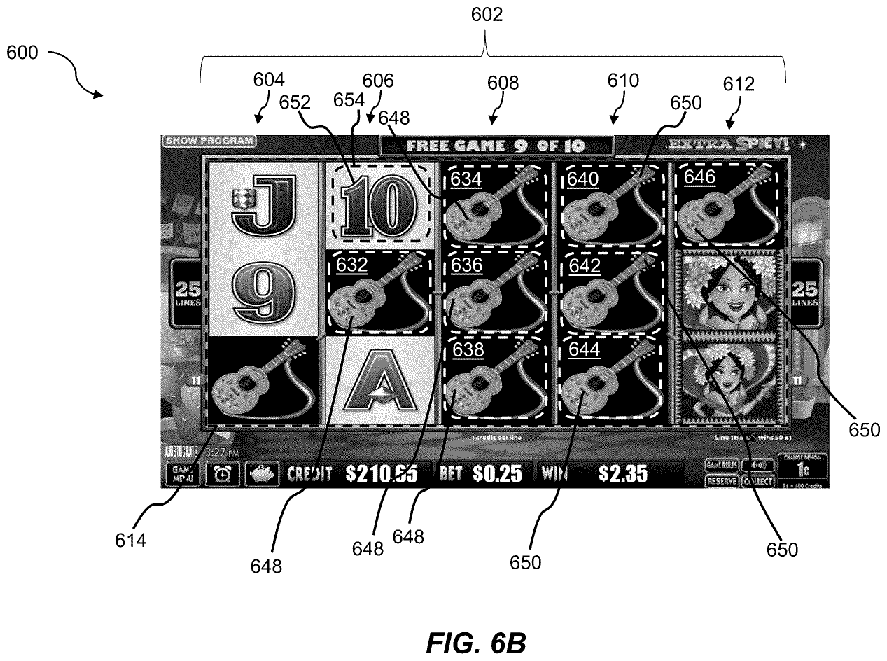

For reveal symbol integration, depending on the RNG output, the dynamic common symbol may appear in a predetermined location relative to the random (e.g., persistent and/or non-persistent) reveal symbols, such as being located adjacent, above, or “behind” the random (e.g., persistent and/or non-persistent) reveal symbols. For example, as shown in pairs of figures including FIGS. 4A/4B, FIGS. 5A/5B, and/or FIGS. 6A/6B, the random persistent reveal symbol may include a gold saloon door that opens to reveal a dynamically-selected symbol, and the random non-persistent reveal symbol may include a green saloon door that opens to reveal the dynamically-selected symbol.

Once the dynamically-selected symbol is selected for display as part of the game outcome, a memory state of the memory (e.g., the memory of the game controller) may be updated accordingly. This may ensure, for example, that for subsequent plays/spins, the persistence of the sticky reveal symbols is accurately maintained.

By isolating a pool of dynamic symbols from a pool of symbols for the standard reel strips, the game controller can make rapid, conditional decisions without having to re-calculate the entire reel configuration. Moreover, this separation allows for dedicated and optimized data structures that hold the dynamic symbols, including corresponding memory allocations that can be adjusted in real time, avoiding delays often introduced by slower memory searches or larger data restructurings. However, added computational complexities are present due to the individual and/or combined effects of effectively three different sets symbols being randomly and dynamically-selected (e.g., (i) random persistent reveal symbols, (ii) random non-persistent reveal symbols, and (iii) a corresponding dynamic common symbol for the random sticky and non-sticky reveal symbols), as well as the associated persistence aspects of the random persistent reveal symbols.

The technical problems addressed herein include: (i) inability for known electronic games that include both non-persistent and persistent symbols to simultaneously trigger a common symbol associated with each of the non-persistent and persistent symbols, including insufficient computational processes and/or configurations for handling such; (ii) inability for known electronic games that include persistent symbols to determine a subsequent reel layout in a subsequent play of the game using dynamically selected symbols associated with the persistent symbol, including insufficient computational processes and/or configurations for handling such; (iii) limitations in dynamic game mechanics in known electronic games, including insufficient computational processes and/or configurations for handling such; (iv) limitations in platform game design, including inability to make changes to symbol types for a given reel strip without swapping out the entire reel strip, and further including insufficient computational processes and/or configurations for handling such; (v) limitations in process control game designs, including inability to control the degree of randomness in a random or pseudo-random gaming environment when replacing symbols, and further including insufficient computational processes and/or configurations for handling such; and/or (vi) limited degrees of randomness that may be used to determine which features are provided in known electronic games, including insufficient computational processes and/or configurations for handling such.

The resulting technical effect and/or technical benefits and/or technical solutions achieved herein include at least one of: (i) implementing both non-persistent and persistent symbols to simultaneously trigger a common symbol associated with each of the non-persistent and persistent symbols to be displayed; (ii) implementing persistent symbols to determine a subsequent reel layout in a subsequent play of the game using dynamically selected symbols associated with the persistent symbol; (iii) providing more degrees of variability and randomness in determining which features are provided in electronic games, without the need for additional computer resources such as computer processing and/or memory resources; (iv) selecting and utilizing specialized memory types and/or specialized memory configurations, including tracking in memory of a status, flag, interrupt, and/or other indicator associated with non-persistent symbols, persistent symbols, and/or common symbols associated with both/each of the non-persistent symbols and the persistent symbols; (v) efficiently managing data corresponding to and/or associated with the selection, storing, processing, and/or display of non-persistent symbols, persistent symbols, and/or common symbols during presentation and/or play of the electronic game; (vi) generating specialized data structures, including linked and/or contingent data structures where a secondary data structure is formatted in association with a format of a primary data structure; (vii) designing specialized game mechanics and/or specialized game process controls, including specialized processing flows therefore; and/or (viii) providing additional information and gameplay features to a user (e.g., player) of the electronic game within a limited amount of display space via an enhanced graphical user interface (GUI) of the game, including providing, via the GUI, additional information to the user during gameplay to apprise the user of the status of triggering common symbols associated with both non-persistent symbols and persistent symbols of an electronic game, such as within a bonus or feature game. Accordingly, the resulting technical effect and/or technical benefits relate to improvements in the underlying technology and/or technological processes in electronic gaming, and includes unconventional, not well-understood, non-routine techniques as described herein.

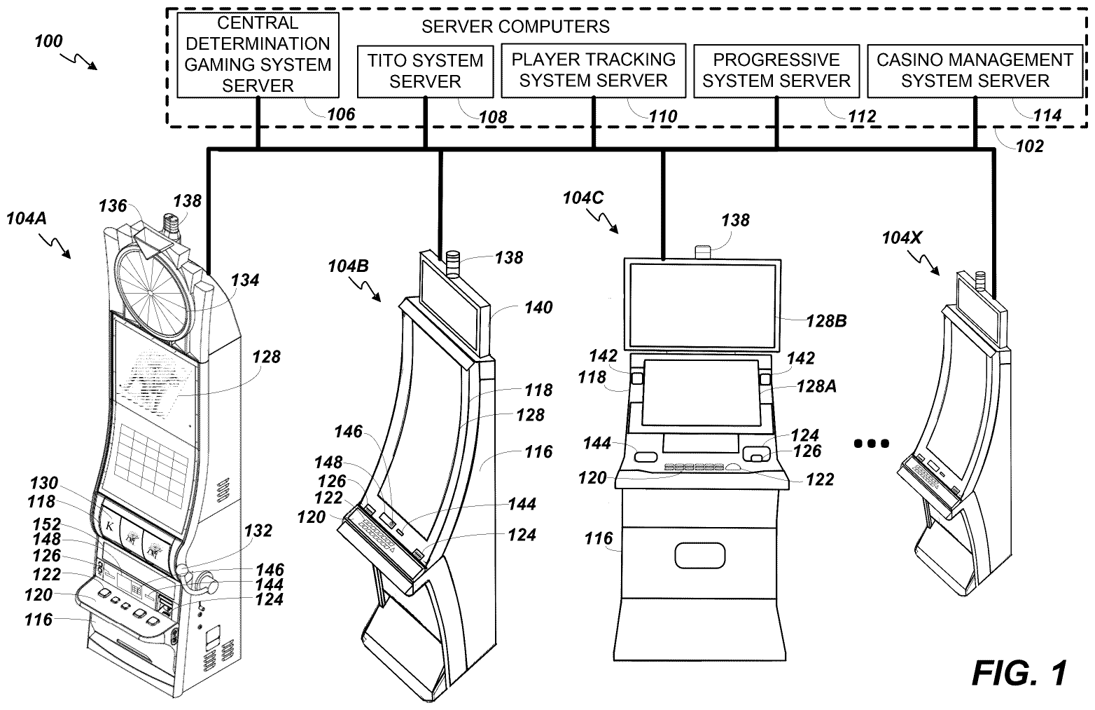

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.01, $0.02, $0.05, or $0.10), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate gameplay.

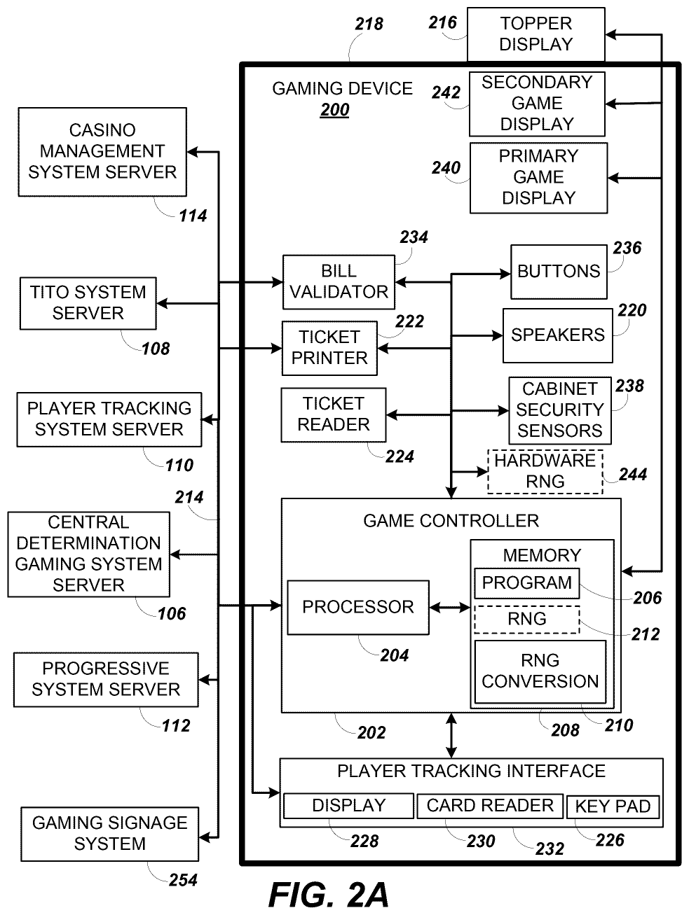

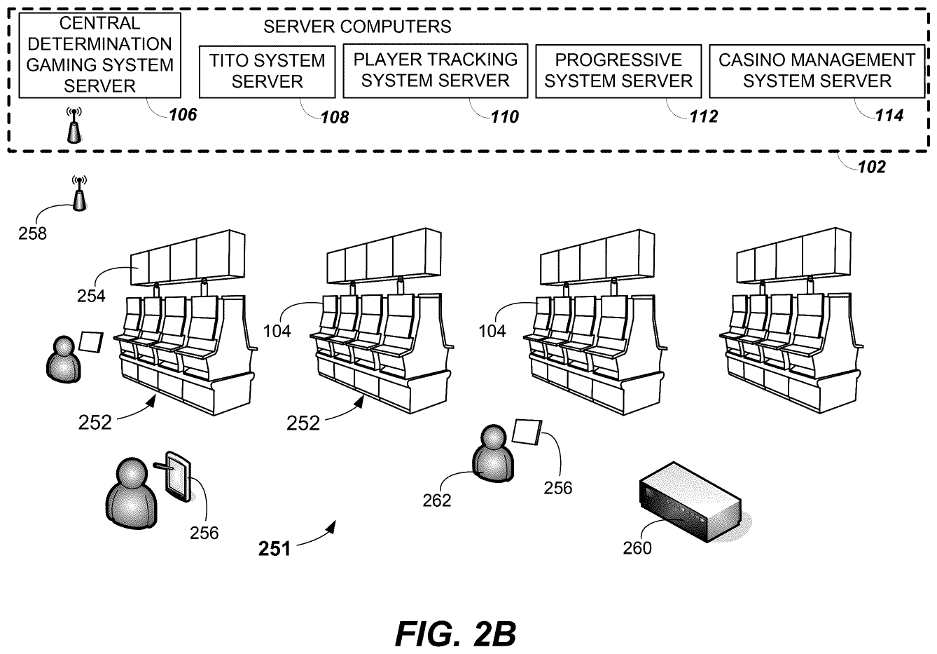

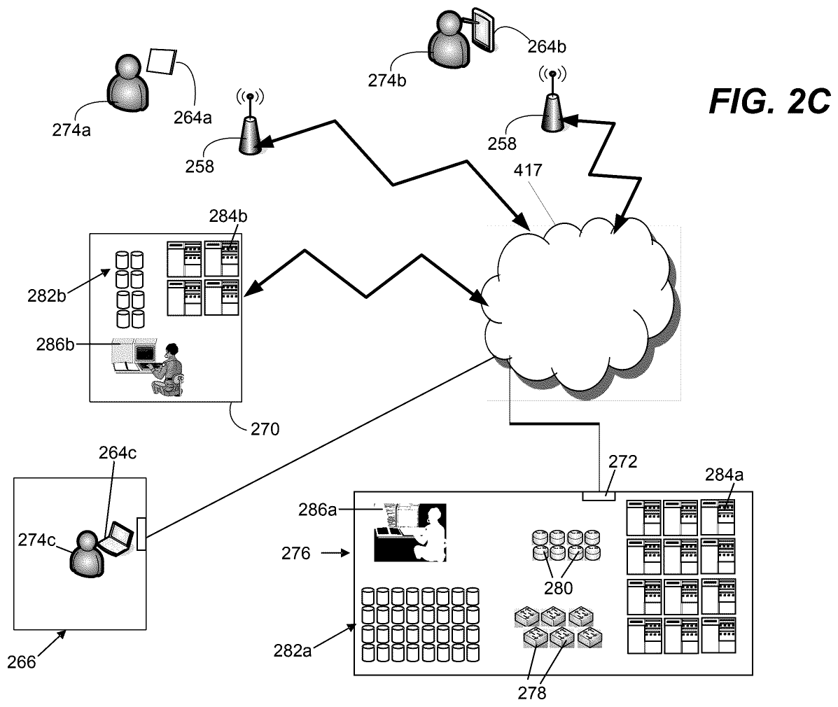

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows gameplay functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary gameplay while secondary display 128B is typically used for bonus gameplay, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do/does retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of gameplays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more user interfaces (UIs), the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of gameplay (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she/they, etc. cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104A-104X. In this example, each bank 252 of EGMs 104A-104X includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104A-104X, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real (e.g., physical) button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online gameplay. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online gameplay, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

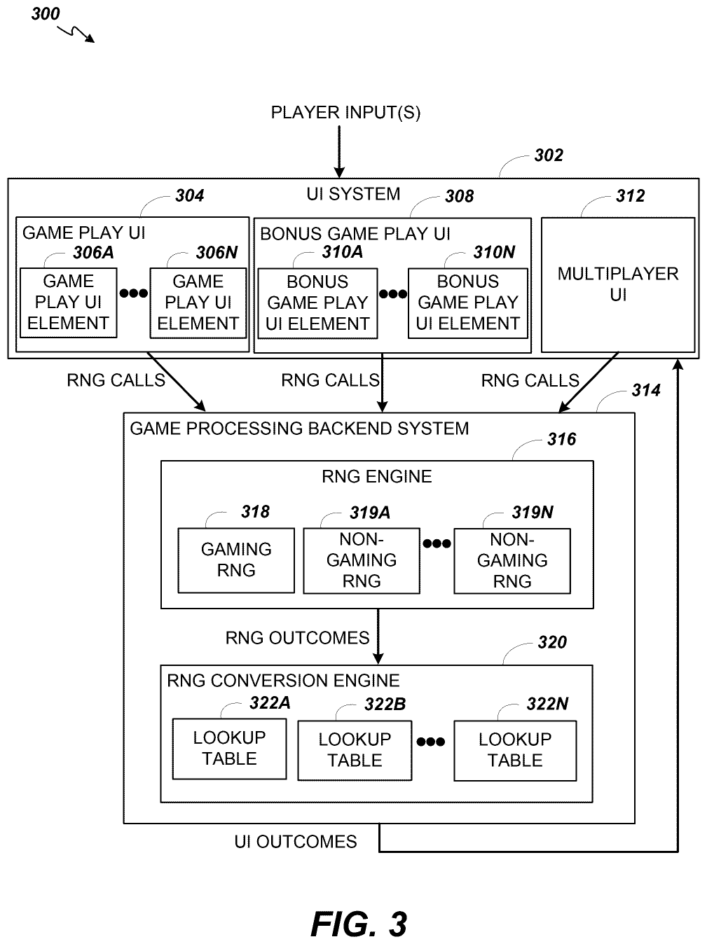

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more gameplay UIs 304, one or more bonus gameplay UIs 308, and one or more multiplayer UIs 312, where each UI type includes one or more mechanical UIs and/or graphical UIs (GUIs). In other words, gameplay UI 304, bonus gameplay UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present gameplay to a player. Using FIG. 3 as an example, the different UI elements are shown as gameplay UI elements 306A-306N and bonus gameplay UI elements 310A-310N.

The gameplay UI 304 represents a UI that a player typically interfaces with for a base game. During a game instance of a base game, the gameplay UI elements 306A-306N (e.g., GUI elements depicting one or more virtual reels) are shown and/or made available to a user. In a subsequent game instance, the UI system 302 could transition out of the base game to one or more bonus games. The bonus gameplay UI 308 represents a UI that utilizes bonus gameplay UI elements 310A-310N for a player to interact with and/or view during a bonus game. In one or more implementations, at least some of the gameplay UI element 306A-306N are similar to the bonus gameplay UI elements 310A-310N. In other implementations, the gameplay UI element 306A-306N can differ from the bonus gameplay UI elements 310A-310N.

FIG. 3 also illustrates that UI system 302 could include a multiplayer UI 312 purposed for gameplay that differs or is separate from the typical base game. For example, multiplayer UI 312 could be set up to receive player inputs and/or presents gameplay information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament gameplay. After tournament gameplay ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for gameplay. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more gameplay UI elements 306A-306N, such as symbols, for the gameplay UI 304. In another example, if the UI outcome is for a bonus game, the UI system could update one or more bonus gameplay UI elements 310A-310N (e.g., symbols) for the bonus gameplay UI 308. In response to updating the appropriate UI, the player may subsequently provide additional player inputs to initiate a subsequent game instance that progresses through the game processing pipeline.

FIGS. 4A, 4B, 5A, 5B, 6A, 6B, and 7 depict example user interfaces (or screenshots thereof) of example free game sessions of a base reel game played on a gaming device (e.g., gaming devices 104A-104X in FIG. 1, and/or gaming device 200 and/or mobile gaming device 256 in FIGS. 2B, 2C).

FIG. 4A illustrates an example user interface (or screenshot thereof) 400 of an example free game (e.g., free spin session) of a base reel game (e.g., base game) played on a gaming device (e.g., gaming devices 104A-104X in FIG. 1, and/or gaming device 200 and/or mobile gaming device 256 and/or user end devices 264a-264c in FIGS. 2B, 2C). Specifically, FIG. 4A shows interface 400, in which a reel outcome is displayed that corresponds to (e.g., presents, represents, and/or is determined from) an output of the gaming device. The output may be a primary (or other) game outcome determined in response to a wager received from a player and in accordance with the RTP, RNG, and other game rules and/or parameters as described herein. Interface 400 may use a mixture of static and/or animated visual graphics, and corresponding sound and/or other sensory implements (e.g., haptic).

Interface 400 may be initiated and presented on a gaming device 104A-104X and/or 200 or as otherwise set forth herein. Specifically, a player may fund the base game via bill validator 234 and/or ticket reader 224. Once funded, the interface 400, which includes a plurality of reels 402 including reels 404, 406, 408, 410, and 412 (also referred to herein as a reel set), each including a plurality of game symbol positions for the display of symbols, may appear on a display (e.g., display 128 shown in FIG. 1) and/or via other displays as described herein, such as the displays described and/or shown in connection with FIGS. 2A-2C). Interface 400 may additionally or alternatively be played on several displays, such as a primary display (e.g., 128A) and a secondary display (e.g., 128B) (each shown in FIG. 1) and/or via other displays as described herein, such as the displays described and/or shown in connection with FIGS. 2A-2C. The plurality of reels 402 may be physical reels and/or virtual reels. As used herein, physical reels are mechanical in nature and may be physically rotated during gameplay. In contrast, virtual reels are rendered or visually created by game controller 202 on a display, such as game display 128, and are merely animated to give the appearance of being spun. The plurality of reels 402 of the example interface 400 include five reels. In other examples, the number of reels may range from one reel to five or more reels in number. The plurality of reels 402 may be referred to as a reel matrix that includes a plurality of symbol positions arranged in a plurality of rows and a plurality of columns. The reel matrix may also therefore be referred to as a “matrix of symbol positions.”

As described herein, during play of the free spin session via interface 400, a plurality of (e.g., game) symbols 414 for a given play, resulting from being selected (e.g., via an RNG call) as described herein, are displayed in the game matrix at symbol positions of each column and row of the plurality of reels 402. Although not central to an understanding of the present disclosure, each of the plurality of reels 402 may include a subset of game symbols within the plurality of game symbols 414 arranged in a vertical column. A number of game symbols of each reel 404-412, corresponding to the number of rows of the plurality of reels 402, is displayed in a column of game symbol positions within the plurality of reels 402 during play of the free spin session via interface 400. For virtual reels, to display symbols from a reel within the plurality of reels 402, processor (e.g., 204 shown in FIG. 2A) may simulate rotation or spinning of one or more of the reels 404-412. Here again, however, mechanical reels having physical reel strips may be used as well. When a respective reel is simulated to halt or stop within an associated column, one or more game symbols may be displayed from the reels 404-412 in the game symbol positions of the column. The game symbols displayed after spinning and stopping each reel strip in a respective column of the reels 404-412 may be referred to herein as a “reel outcome.” More broadly, an “outcome” of a reel game, such as a free spin session of a base reel game refers to the game symbols displayed in the reels 404-412 after the reel are spun and stopped. Thus, a rotation and stopping of the reels (also referred to herein as a “spin and stop sequence”) may be simulated by processor (e.g., 204) within the columns of the plurality of reels 402 to cause a reel outcome, including a plurality of game symbols, to be displayed within the columns of the plurality of reels 402.

As shown in the exemplary embodiment of FIG. 4A, and as further described herein, the plurality of game symbols 414 included and/or displayed within the plurality of reels 402 includes and/or are formed from various symbol types. For example, graphic game symbols of the plurality of game symbols include predetermined graphics, symbols, and/or artworks that can be based on a theme, story, and/or visual representation of interface 400. Additionally, or alternatively, graphic game symbols include suitable graphics, symbols, and/or artworks commonly associated with gaming device (e.g., “BAR,” “SPIN,” “WILD,” etc.). The plurality of game symbols may also include cash-on-reel (COR) symbols displayed within the plurality of reels 402. COR symbols include, display, depict, and/or are associated with a predetermined credit value (e.g., COR credit value) that can provide additional award credits to the player during the free spin session (or the base game) and/or define credit values for the bonus event, as discussed herein.

Interface 400 may also include a credit indicator 416 indicating an amount of credits available, a bet (e.g., wager) indicator 418 indicating a bet amount, a win indicator 420 indicating an amount won from a (e.g., prior) play of the game, a denomination indicator 422 indicating a current denomination amount (and/or providing the player with an option to change a denomination amount to any one denomination provided for selection (e.g., 1 cent, 2 cents, $1, and so on and so forth at any desired amount and/or interval permissible under gaming rules/regulations)), a “free game” indicator 424 indicating an amount of total and remaining free games available (e.g., “FREE GAME X OF Y”, where “Y” may increase as a result of certain game outcomes such as winning additional free games), and a lines (e.g., paylines) indicator 426, indicating how many lines are being bet (which may be selected by a player according to the line options available in the game). Credit indicator 416 displays a credit balance (calculated as a sum total of credits input and awards accrued minus wagers placed) accrued until a player cashes out. Wager indicator 418 represents and/or displays the credit and/or monetary value being wagered during each play of the base game as determined by the player. Win indicator 420 displays a credit and/or monetary value awarded during outcomes of the bonus event. In operation, the reel outcome presented during play of the free spin sessions via interface 400 (or the base game) corresponds to, presents, represents, and/or is determined from a certain game outcome.

Interface 400 may include within the plurality of symbols 414 of the game outcome one or more random reveal dynamic symbols, which may include: (i) random non-persistent reveal dynamic symbols 428 (also referred to herein as random non-persistent reveal dynamic symbols 428, or simply non-persistent (e.g., “non-sticky”) reveal symbols 428), and (ii) random persistent reveal dynamic symbols 430 (also referred to herein as random persistent reveal dynamic symbols 430, or simply persistent (e.g., “sticky”) reveal symbols 430), each of which randomly land during play of the game. For example, and without limitation, the two types of reveal symbols (e.g., 428, 430) may be configured as a visual graphic icon that depicts a saloon door symbol presented in one or more colors, such as green and/or gold saloon doors, where green saloon doors may represent non-sticky reveal symbols (e.g., symbol 428) which will reveal a dynamically selected symbol (shown in FIG. 4B as the “10” symbol, e.g., the “common symbol”), and gold saloon doors that may represent sticky reveal symbols (e.g., symbol 430) which will reveal the same dynamically selected symbol (shown in FIG. 4B as the “10” symbols, e.g., the “common symbol”). When the reels 404-412 come to a complete stop, both the green (e.g., symbol 428) and gold (e.g., symbol 430) saloon doors open to reveal the same dynamically selected symbol (the common “10” symbol shown in FIG. 4B) in each reel position. That is, the dynamically selected symbol (shown in FIG. 4B) that is revealed is the same symbol for each respective green (e.g., symbol 428) and gold (e.g., symbol 430) door. The dynamically selected common symbols (shown in FIG. 4B) revealed by the doors (e.g., symbols 428, 430) may, or may not, result in a prize being awarded (e.g., a prize may be a free game as shown in FIG. 5B, or a prize amount). After the dynamically selected revealed symbols have been revealed and any prizes have been awarded, the player can once again spin the reels of the next free game. In doing so, the symbol positions located at the green (e.g., symbol 428) saloon doors will reset and revert to normal symbol positions once again. However, the symbol positions located at the gold (e.g., symbol 430) doors will stay on the reels throughout the remaining free games. Once the subsequent free game reels have come to a stop, the symbol positions located at the gold (e.g., symbol 430) saloon doors will once again reveal a dynamically selected symbol to the player. Hence the term “random persistent reveal dynamic symbols” used herein with respect to the gold door symbol positions (e.g., symbol 430 positions). As shown in FIG. 4A, random non-persistent reveal symbol 428 is at position 432 within the plurality of reels 402 (and more specifically within reel 406), and random persistent reveal symbols 430 are at positions 434 and 436 within the plurality of reels 402 (more specifically, position 434 is within reel 410 and position 436 is within reel 412). Each of symbols 428 and 430 may be randomly and dynamically selected as described herein, although additional or alternatives manners for selecting symbols 428 and 430 are envisioned by the present disclosure.

FIG. 4B illustrates the example interface 400 as described and shown in connection with FIG. 4A, except with a first dynamically selected symbol 438 and a second dynamically selected symbol(s) 440 shown in connection with the revealing (e.g., opening) of the green (e.g., symbol 428) and gold (e.g., symbol 430) doors, respectively. For example, when compared with FIG. 4A, the first dynamically selected symbol 438 is shown in FIG. 4B at the same position that random non-persistent reveal symbol 428 was present, and the second dynamically selected symbols 440 are at the same positions that random persistent reveal symbols 430 were respectively present. As shown in FIG. 4B, the first dynamically selected symbol 438 and the second dynamically selected symbols 440 represent the same symbol (e.g., a “10” symbol). The first dynamically selected symbol 438 is at position 432 within the plurality of reels 402 (and more specifically within reel 406), matching the position of symbol 428 in FIG. 4A. The second dynamically selected symbols 440 are at positions 434 and 436 within the plurality of reels 402 (more specifically, position 434 is within reel 410 and position 436 is within reel 412), each respectively matching the positions of their corresponding symbol 430 in FIG. 4A. Symbol 442 (e.g., a “K” symbol for the free game instance shown in FIGS. 4A and 4B) at position 444 in FIG. 4B is an example of one symbol of a plurality of other symbol types that may land as part of the plurality of symbols 414 within the same free game (e.g., free game 3 of 6) of the session-symbol 442 is not limited to that shown in FIGS. 4A and 4B. The use of “first” and “second” in connection with the first dynamically selected symbol 438 and the second dynamically selected symbols 440 does not necessarily imply any order in which the symbols are determined, displayed, etc.

FIG. 5A illustrates an example user interface (or screenshot thereof) 500 of an example free game (e.g., free spin session) of a base reel game played on a gaming device (e.g., gaming devices 104A-104X in FIG. 1, and/or gaming device 200 and/or mobile gaming device 256 and/or user end devices 264a-264c in FIGS. 2B, 2C). The interface 500 of the free spin session shown in FIG. 5A is generally similar to or the same as interface 400 described herein except for the types of displayed symbols and other miscellaneous aspects, and as such common functions and other common operations is/are not repeated. Interface 500 may use a mixture of static and/or animated visual graphics, and corresponding sound and/or other sensory implements (e.g., haptic).

Interface 500 includes a plurality of reels 502 including reels 504, 506, 508, 510, and 512 (also referred to herein as a reel set). During play of the free spin session via interface 500, a plurality of game symbols 514 may be selected using techniques described herein for display at symbol positions on the plurality of reels 502. Interface 500 may also include a credit indicator 516, a bet (e.g., wager) indicator 518, a win indicator 520, a denomination indicator 522, a “free game” indicator 524, and a lines (e.g., paylines) indicator 526, each being configured as described above in connection with corresponding elements 416/418/420/422/424/426 in FIGS. 4A and 4B.

Interface 500 may include within the plurality of symbols 514 of the game outcome one or more random reveal dynamic symbols, which may include: (i) random non-persistent reveal dynamic symbols 528 (also referred to herein as random non-persistent reveal dynamic symbols 528, or simply non-persistent (e.g., non-sticky) reveal symbols 528), and (ii) random persistent reveal dynamic symbols 530 (also referred to herein as random persistent reveal dynamic symbols 530, or simply persistent (e.g., “sticky”) reveal symbols 530), each of which randomly land during play of the game. For example, and without limitation, the two forms of reveal symbols (e.g., 528, 530) may be configured as a visual graphic icon that depicts a saloon door symbol of one or more colors, such as green and/or gold saloon doors, where green saloon doors represent non-sticky reveal symbols (e.g., symbol 528) which will reveal a dynamically selected symbol (shown in FIG. 5B as the “FREE GAME” symbol), and gold saloon doors represent sticky reveal symbols (e.g., symbol 530) which will reveal the same dynamically selected symbol as the green doors (e.g., the same “FREE GAME” symbol shown in FIG. 5B). That is, when the reels 504-512 come to a complete stop, both the green (e.g., symbol 528) and gold (e.g., symbol 530) saloon doors open to reveal the same dynamically selected symbol (shown in FIG. 5B) in each corresponding reel position. The dynamically selected common symbol (shown in FIG. 5B) that is revealed is the same symbol for each respective green (e.g., symbol 528) and gold (e.g., symbol 530) door. The dynamically selected common symbols (shown in FIG. 5B) revealed by the doors (e.g., symbols 528, 530) may, or may not, result in a prize being awarded (e.g., a prize may be a free game as shown in FIG. 5B, or a prize amount). After the dynamically selected common symbols have been revealed and any prizes have been awarded, the player can once again spin the reels of the next free game. In doing so, the symbol positions located at the green (e.g., symbol 528) saloon doors will reset and revert to normal symbol positions once again. However, the symbol positions located at the gold (e.g., symbol 530) doors will stay on the reels throughout the remaining free games. Once the subsequent free game reels have come to a stop, the symbol positions located at the gold (e.g., symbol 530) saloon doors will once again reveal a dynamically selected symbol to the player. As shown in FIG. 5A, random non-persistent reveal symbols 528 are at positions 532 and 534 within the plurality of reels 502 (more specifically, position 532 is within reel 504 and position 534 is within reel 512), and random persistent reveal symbols 530 are at positions 536 and 538 within the plurality of reels 502 (more specifically, position 536 is within reel 510 and position 538 is within reel 512). Each of symbols 528 and 530 may be randomly and dynamically selected as described herein, although additional or alternatives manners for selecting symbols 528 and 530 are envisioned by the present disclosure.

FIG. 5B illustrates the example interface 500 as described and shown in connection with FIG. 5A, except with a first dynamically selected symbol(s) 540 and a second dynamically selected symbol(s) 542 shown in connection with the revealing (e.g., opening) of the green (e.g., symbol 528) and gold (e.g., symbol 530) doors, respectively. For example, when compared with FIG. 5A, the first dynamically selected symbol 540 is shown in FIG. 5B at the same position that random non-persistent reveal symbol 528 was present, and the second dynamically selected symbols 542 are at the same positions that random persistent reveal symbols 530 were respectively present. As shown in FIG. 5B, the first dynamically selected symbol 540 and the second dynamically selected symbols 542 represent the same symbol (e.g., “FREE GAME”). As shown in FIG. 5B, first dynamically selected symbols 540 are at positions 532 and 534 within the plurality of reels 502 (more specifically, position 532 is within reel 504 and position 534 is within reel 512), and second dynamically selected symbols 542 are at positions 536 and 538 within the plurality of reels 502 (more specifically, position 536 is within reel 510 and position 538 is within reel 512). Total available free games portion 544 of free game indicator 524 may be updated to reflect the total current amount of free games available, which may vary subject to the landing of FREE GAME symbols on the reels (e.g., in the embodiment shown in FIG. 5B, this is depicted by way of symbols 540 and 542 landing on the plurality of reels 502 four times, each including a FREE GAME therewith, thereby adding 4 free games to the amount of free games shown in FIG. 5A (e.g., the total amount of free games increase from 6 in FIG. 5A to 10 in FIG. 5B due to the landing of four total symbols 540 and 542 which happened to randomly be FREE GAME symbols to award additional free games). As shown in FIGS. 5A and 5B, the positions 532, 534, 536, and 538 correspond to one another, and the first dynamically selected symbols 540 and the second dynamically selected symbols 542 are the same symbol as one another. Symbol 546 (e.g., a “Q” symbol for the free game instance shown in FIGS. 5A and 5B) at position 548 in FIG. 5B is an example of one symbol of a plurality of other symbol types that may land as part of the plurality of symbols 514 within free game 4 of 10—symbol 546 is not limited to that shown in FIGS. 5A and 5B.

FIG. 6A illustrates an example user interface (or screenshot thereof) 600 of an example free game (e.g., free spin session) of base reel game (e.g., base game) played on a gaming device (e.g., gaming devices 104A-104X in FIG. 1, and/or gaming device 200 and/or mobile gaming device 256 and/or user end devices 264a-264c in FIGS. 2B, 2C). Interface 600 is generally similar to or the same as interfaces 400 and/or 500 described herein except for the types of displayed symbols and other miscellaneous aspects, and as such common functions and other common operations is/are not repeated. Interface 600 may use a mixture of static and/or animated visual graphics, and corresponding sound and/or other sensory implements (e.g., haptic).

Interface 600 includes a plurality of reels 602 including reels 604, 606, 608, 610, and 612 (also referred to herein as a reel set). During play of the free spin session via interface 600, a plurality of game symbols 614 may be selected for display at symbol positions on the plurality of reels 602. Interface 600 may also include a credit indicator 616, a bet (e.g., wager) indicator 618, a win indicator 620, a denomination indicator 622, a “free game” indicator 624, and a lines indicator 626, as described above in connection with elements 416/418/420/422/424/426 in FIGS. 4A and 4B and like elements in FIGS. 5A and 5B.

Interface 600 may include within the plurality of symbols 614 of the game outcome one or more random reveal dynamic symbols, which may include: (i) random non-persistent reveal dynamic symbols 628 (also referred to herein as random non-persistent reveal dynamic symbols 628, or simply non-persistent (e.g., “non-sticky” reveal symbols 628), and (ii) random persistent reveal dynamic symbols 630 (also referred to herein as random persistent reveal dynamic symbols 630, or simply persistent (e.g., “sticky”) reveal symbols 630), each of which randomly land during play of the game. For example, and without limitation, the random reveal symbols may be configured as a visual graphic icon that depicts a saloon door symbol of one or more colors, such as green and/or gold saloon doors, where green saloon doors represent non-sticky reveal symbols (e.g., symbol 628) which will reveal a dynamically selected symbol (shown in FIG. 6B), and gold saloon doors represent sticky reveal symbols (e.g., symbol 630) which will reveal the same dynamically selected symbol (shown in FIG. 5). When the reels 604-612 come to a complete stop, both the green (e.g., symbol 628) and gold (e.g., symbol 630) saloon doors open to reveal the same dynamically selected symbol (shown in FIG. 6B) in each corresponding reel position. The dynamically selected common symbol (in this case, the various guitar symbols shown in FIG. 6B (except for the bottom left guitar symbol)) is the same symbol for each respective green (e.g., symbol 628) and gold (e.g., symbol 630) door. The dynamically selected revealed symbols (shown in FIG. 6B) revealed by the doors (e.g., symbols 628, 630) may, or may not, result in a prize being awarded (e.g., a prize may be a free game as shown in FIG. 5B, or a prize amount). After the dynamically selected common symbols have been revealed and any prizes have been awarded, the player can once again spin the reels of the next free game. In doing so, the symbol positions located at the green (e.g., symbol 628) saloon doors will reset and revert to normal symbol positions once again. However, the symbol positions located at the gold (e.g., symbol 630) doors will stay on the reels throughout the remaining free games. Once the subsequent free game reels have come to a stop, the symbol positions located at the gold (e.g., symbol 630) saloon doors will once again reveal a dynamically selected symbol to the player. As shown in FIG. 6A, random non-persistent reveal symbols 628 are at positions 632, 634, 636, and 638 within the plurality of reels 602 (more specifically, position 632 is within reel 606, and positions 634, 636, and 638 are within reel 608), and random persistent reveal symbols 630 are at positions 640, 642, 644, and 646 within the plurality of reels 602 (more specifically, positions 640, 642, and 644 are within reel 610 and position 646 is within reel 612). Each of symbols 628 and 630 may be randomly and dynamically selected as described herein, although additional or alternatives manners for selecting symbols 428 and 430 are envisioned by the present disclosure. FIGS. 4A, 4B, 5A, 5B, 6A, and 6B may be viewed in sequence. For example, when comparing FIG. 6A to FIG. 5B, 5 free game sessions have transpired (e.g., where FIG. 5B shows FREE GAME 4 of 10, and FIG. 6A shows FREE GAME 9 of 10).

FIG. 6B illustrates the example free spin session of interface 600 as described and shown in connection with FIG. 6A, except with a first dynamically selected symbol 648 and a second dynamically selected symbol 650 shown in connection with the revealing (e.g., opening) of the green (e.g., symbol 628) and gold (e.g., symbol 630) doors. For example, when compared with FIG. 6A, the first dynamically selected symbol 648 is shown in FIG. 6B at the same position that random non-persistent reveal symbol 628 was present, and the second dynamically selected symbols 650 are at the same positions that random persistent reveal symbols 630 were respectively present. As shown in FIG. 6B, the first dynamically selected symbol 648 and the second dynamically selected symbols 650 represent the same symbol (e.g., a guitar symbol). As shown in FIG. 6B, first dynamically selected symbols 648 are at positions 632, 634, 636, and 638 within the plurality of reels 602 (more specifically, position 632 is within reel 606 and positions 634, 636, and 638 are within reel 608), and second dynamically selected symbols 650 are at positions 640, 642, 644, and 646 within the plurality of reels 602 (more specifically, positions 640, 642, and 644 are within reel 610 and position 646 is within reel 612). As shown in FIGS. 6A and 6B, the positions 632, 634, 636, and 638 (associated with symbols 628) and positions 640, 642, 644, and 646 (associated with symbols 630) correspond to one another, and the first dynamically selected symbols 648 and the second dynamically selected symbols 650 are the same symbol as one another. A portion the same as or similar to portion 544 shown in FIG. 5B may be present in any embodiment such as represented in FIGS. 4B and 6B (e.g., depending on if FREE GAME symbols land on the reels, thereby adding to the total amount of free games available). Symbol 652 (e.g., a “10” symbol for the free game instance shown in FIGS. 6A and 6B) at position 654 in FIG. 6B is an example of one symbol of a plurality of other symbol types that may land as part of the plurality of symbols 614 within the session (e.g., free game 9 of 10)—symbol 652 in not limited to that shown in FIGS. 6A and 6B. The use of “first dynamically selected symbol” (e.g., for element 648 and like elements in FIGS. 4B and 5B) and “second dynamically selected symbols” (e.g., for element 650 and like elements in FIGS. 4B and 5B) does not necessarily imply an order in which these symbols were selected, as “first” and “second” may instead be used to indicate an association with the corresponding random persistent/non-persistent reveal symbol (e.g., “first” being associated with random non-sticky reveal symbol, and “second” being associated with random sticky reveal symbol, or vice versa).

Further regarding the persistent (e.g., “sticky”) aspects of symbols 430, 530, and 630, FIGS. 4A, 4B, 5A, 5B, 6A, 6B can be viewed as being part of a sequence within a same overall free game session of the game. For example, the screenshot shown in FIG. 5A may represent a subsequent, or next, play (e.g., subsequent (or next) spin) after the screenshot shown in FIG. 4B, and the screenshot shown in FIG. 6A may represent another next play (e.g., a subsequent spin) after the screenshot shown in FIG. 5B (where “next” in this context may mean immediately next or not immediately next). Put another way, any particular free game (e.g., FREE GAME 3 of 6) within the free game session may be referred to as a “designated play” (which may also be referred to as a “current” play, or a “prior play” when referenced in connection with any “next play” of the game), and any subsequent free game (e.g., FREE GAME 4 of 6 . . . FREE GAME 6 of 6, etc.) of the free game session may be referred to as a “next play.”

More specifically, FIG. 4B shows the game outcome of FREE GAME 3 of 6, where: (i) random non-persistent reveal symbol 428 in position 432 was revealed as a “10” symbol (e.g., a first dynamically selected symbol 438 at position 432), and (ii) random persistent reveal symbols 430 in positions 434 and 436 were revealed as “10” symbols (e.g., second dynamically selected symbols 440 at positions 434 and 436). FIG. 5A represents FREE GAME 4 of 6 (e.g., the next spin within the free game session following FREE GAME 3 of 6 as shown in FIGS. 4A and 4B). FIG. 5B shows that random persistent reveal symbols 430 (shown in positions 434 and 436 in FIGS. 4A and 4B) have remained persistent (or “sticky”) in the following free game (e.g., FREE GAME 4 of 6) of the session, and are located at positions 536 and 538 (where position 434=position 536 and position 436=position 538). However, in FREE GAME 4, new random non-persistent reveal symbols 528 have landed in positions 532 and 534, each of which being different from position 432 shown in FIGS. 4A and 4B. FIG. 5B shows that the same FREE GAME symbol is revealed for each of random non-persistent reveal symbols 528 and random persistent reveal symbols 530 in the manner described herein. FIG. 6A represents FREE GAME 9 of 10 (e.g., a spin within the free game session that is 5 spins after the fourth spin shown in FIGS. 5A and 5B, wherein FIG. 5B revealed four FREE GAME symbols that increased the total free game spins of the free game session to 10 spins, as reflected in FIGS. 6A and 6B). FIG. 6A shows random persistent reveal symbols 630 at positions 640 and 646. These random persistent reveal symbols 630 at positions 640 and 646 are the same symbols as random persistent reveal symbols 430 shown in positions 434 and 436 in FIGS. 4A and 4B and random persistent reveal symbols 530 at positions 536 and 538 in FIGS. 5A and 5B because they have remained persistent (or “sticky”) in the subsequent spins of the free game session (e.g., FREE GAME 5 of 10, FREE GAME 6 of 10, FREE GAME 7 of 10, FREE GAME 8 of 10, and FREE GAME 9 of 10). However, FIG. 6A shows that additional random persistent reveal symbols 630 have, at some point within free games 5-9, landed at positions 642 and 644. FIG. 6A also shows new random non-persistent reveal symbols 628 have landed at positions 632, 634, 636, and 638, where any landing position similar to symbols 428/528 is by random coincidence because symbols 428/528/628 are not sticky (not persistent). FIG. 6B shows that the same guitar symbol is revealed for each of random non-persistent reveal symbols 628 and random persistent reveal symbols 630 in the manner described herein.

When comparing plurality of symbols 414 (FIGS. 4A, 4B), plurality of symbols 514 (FIGS. 5A, 5B), and plurality of symbols 614 (FIGS. 6A, 6B), it can be seen that random persistent reveal symbols 430 (in positions 434 and 436), random persistent reveal symbols 530 (in positions 536 and 538, where position 536 is the same as position 434 and position 538 is the same as position 436), and random persistent reveal symbols 630 (in positions 640 and 646, where position 640 is the same as positions 434/536 and position 646 is the same as positions 436/538) remain persistent throughout the span of free game spins (e.g., spins 3 through 9) within the overall free game session, and that the other symbols in the plurality of symbols 414/514/614 change upon each spin within the overall free game session. For example, when comparing FIG. 4A (e.g., FREE GAME 3 of 6) to FIG. 5A (e.g., FREE GAME 4 of 6), it can be seen that no additional/new random persistent reveal symbols landed, whereas when comparing FIG. 5A (e.g., FREE GAME 4 of 6) to FIG. 6A (e.g., FREE GAME 9 of 10), it can be seen that between FREE GAME 4 and FREE GAME 9, two additional/new random persistent reveal symbols landed and persisted (as well as extra free games having been awarded to increase from 6 free games in FIG. 4A to 9 free games in FIG. 6A). As an example of how the other symbols within plurality of symbols 414/514/614 change with each free game spin within a free game session (whereas random persistent reveal symbols 430/530/630 remain persistent with each free game spin within a free game session), symbol 442 at position 444 is a “K” symbol (shown in FIG. 4B), symbol 546 at position 548 is a “Q” symbol (shown in FIG. 5B), and symbol 652 at position 654 is a “10” symbol (shown in FIG. 6B). However, each time both random non-persistent reveal symbols 428/528/628 and random persistent reveal symbols 430/530/630 land in any same free game, they reveal a common symbol. In FIG. 4B, the common symbol associated with the composite random persistent/non-persistent reveal symbols is a “10” symbol (where the “10” symbol is a representation of a random symbol that is revealed as first dynamically selected symbol 438 and second dynamically selected symbols 440). In FIG. 5B, the common symbol associated with the composite random persistent/non-persistent reveal symbols is a “FREE GAME” symbol (where the “FREE GAME” symbol is a representation of a random symbol that is revealed as first dynamically selected symbols 540 and second dynamically selected symbols 542). In FIG. 6B, the common symbol associated with the composite random persistent/non-persistent reveal symbols is a “Guitar” symbol (where the “Guitar” symbol is a representation of a random symbol that is revealed as first dynamically selected symbols 648 and second dynamically selected symbols 650).

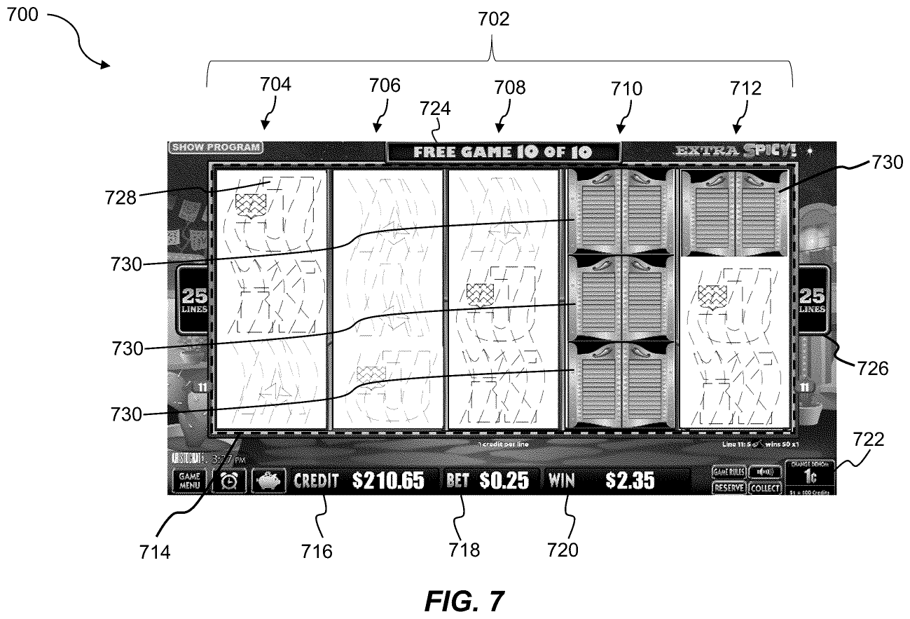

FIG. 7 illustrates an example user interface (or screenshot thereof) 700 of an example free game (e.g., free spin session) of a base reel game (e.g., base game) played on a gaming device (e.g., gaming devices 104A-104X in FIG. 1, and/or gaming device 200 and/or mobile gaming device 256 and/or user end devices 264a-264c in FIGS. 2B, 2C). Interface 700 is generally similar to or the same as interfaces 400, 500, and/or 600 described herein except for the types of displayed symbols and other miscellaneous aspects, and as such common functions and other operation is/are not repeated. Interface 700 may use a mixture of static and/or animated visual graphics, and corresponding sound and/or other sensory implements (e.g., haptic).

Interface 700 includes a plurality of reels 702 including reels 704, 706, 708, 710, and 712 (also referred to herein as a reel set). During play of the free spin session of the base reel game, a plurality of game symbols 714 may be selected for display at symbol positions on the plurality of reels 702. Interface 700 may also include a credit indicator 716, a bet (e.g., wager) indicator 718, a win indicator 720, a denomination indicator 722, a “free game” indicator 724, and a lines indicator 726, as described above with respect to elements 416/418/420/422/424/426 in FIGS. 4A and 4B and like elements in FIGS. 5A-6B.

FIG. 7 illustrates a transition appearance of reels of a next free game spin (e.g., FREE GAME 10 of 10) after the free game spin played in FIG. 6B (e.g., FREE GAME 9 of 10). More specifically, FIG. 7 emphasizes the hold & spin aspect described herein where reels 704, 706, 708, 710, and 712 and the symbol positions thereof are spinning, as illustrated by spinning reels 728, except for the positions where random persistent reveal symbols 730 are present (random persistent reveal symbols 730 are also referred to herein as random persistent reveal symbols 730, and are the same as random persistent reveal symbols 430/530/630 shown in FIGS. 4A/5A/6A, respectively). These symbols 730 are held within their respective reel positions as described herein. FIG. 7 reflects the random persistent reveal symbols 730 that have accumulated through free game spins 1-9 of the free game session (as shown through FIGS. 4A, 5A, and 6A). Upon conclusion of free game 10 (e.g., no additional free games are won), the free game session may end and the player may be returned to a base game. The base game may be substantially similar to the interfaces 400/500/600/700 shown in FIGS. 4A-7, except without a “FREE GAME” indicator 424/524/624/724 as shown in FIGS. 4A/5A/6A/7, respectively. For example, a certain game outcome (e.g., landing a certain combination and/or type of symbols) within the base game may trigger entry into a free spin session as represented in FIGS. 4A-7. While FIGS. 4A-7 reflect the random persistent reveal symbols relative to free games session, the same mechanic could be used in a base game and/or other feature or bonus games, and is not limited to only a free games (e.g., free spins) gameplay environment.

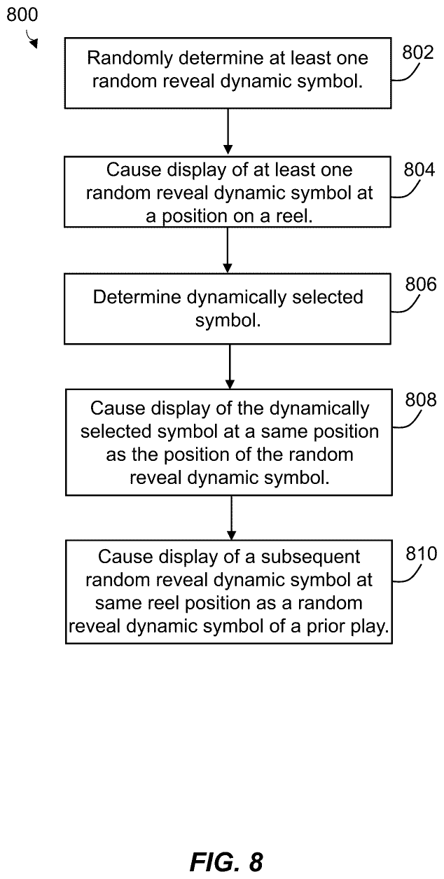

FIG. 8 illustrates an example method 800 for providing the electronic game shown, for example, in FIGS. 4A, 4B, 5A, 5B, 6A, 6B, and 7. Step 802 includes randomly determining at least one random reveal symbol. The at least one random reveal symbol may include one or more of each of (i) random non-persistent reveal symbol (e.g., symbol 428/528/628), and (ii) a random persistent reveal symbol (e.g., symbol 430/530/630/730). This may be accomplished by an RNG call and/or other rule of the electronic game as described herein. Step 804 includes causing display of a plurality of symbols for a designated play of an electronic game, the plurality of symbols including at least one random reveal symbol located at a position on a reel of a reel set of the designated play of the electronic game and associated with a dynamically selected symbol (e.g., symbols 438/440, 540/542, 648/650). Step 806 includes determining the dynamically selected symbol. This may be accomplished by an RNG call and/or other rule of the electronic game as described herein. Step 808 includes causing display of the dynamically selected symbol at a same position as the position of the at least one random reveal symbol. The display of the at least one random reveal symbol is stopped upon the display of the dynamically selected symbol (see for example FIGS. 4A and 4B at position 434). In the case where each of a non-persistent and persistent symbol are displayed, the dynamically selected symbol(s) will be the same for each non-persistent and persistent symbol (see for example symbols 648 and 650 in FIG. 6B). Step 810 includes, depending on a type of the at least one random reveal symbol (e.g., a random persistent reveal symbol), causing display of a subsequent at least one random reveal symbol (e.g., a random persistent reveal symbol) at a position on a reel of a reel set of a subsequent play of the electronic game. The position on the reel of the reel set of the subsequent play of the electronic game being the same as the position on the reel of the reel set of the prior play of the electronic game (see for example position 436 in FIG. 4A and position 646 in FIG. 6A).

Managing the underlying computational tasks for executing the dynamic and persistent aspects described herein is a complex task, and routine techniques and system configurations are not well-suited to handle them. Accordingly, described herein is/are specialized memory types (e.g., dedicated memory such as cache memory) and/or specialized processing and/or memory techniques (e.g., storing, tracking, etc.) for efficiently managing and/or processing the random non-persistent reveal symbols (e.g., 428/528/628), the random persistent reveal symbols (e.g., 430/530/630), and the associated common symbols (e.g., 438/440, 540/542, 648/650) that reveal when the random non-persistent reveal symbols (e.g., 428/528/628) and/or the random persistent reveal symbols (e.g., 430/530/630) land in a same free game.

For example, memory 208 may include a dedicated memory or memory portion such as local cache memory that may be utilized to store data corresponding to the random persistent/non-persistent reveal symbols and common symbols. In one embodiment, when a first random non-sticky or sticky reveal symbol lands, data corresponding to a common symbol to be revealed by the first random non-sticky or sticky reveal symbol and any subsequent random non-sticky or sticky reveal symbols that land in the same free game may be stored in the dedicated memory such as a cache memory for faster retrieval and/or display of the common symbol for the subsequent random non-sticky or sticky reveal symbols. This may include various prioritization of processes. For example, there may be an order of instructions that prioritizes determining the random persistent/non-persistent reveal symbols and common symbols over the other plurality of symbols (e.g., 442, 546, 652) for a given free game spin, where processing power may be shifted/distributed accordingly to resolve higher priority items first. This may include distributed computing aspects and the like, such as by implementing additional processors 204, etc.

Customized tracking of the common symbols and/or the persistent symbols (e.g., the random persistent reveal symbols (e.g., 430/530/630)) may be implemented using dedicated data structures (such as tables, arrays, etc.) stored in a memory such as a high-speed volatile memory as described herein. Each element in these structures may contain a symbol identifier, position data including current position, and any additional state information. When a new spin occurs, the game controller (e.g., 202) may first reference this memory to preserve the persistent symbol and/or update for the common symbol. This targeted tracking and updating not only ensures the correct display of the particular symbols but also minimizes processing overhead, making gameplay smoother and faster.

Additional memory management techniques specific to executing the various random stick/non-sticky reveal symbols and corresponding common symbols described herein may further and/or additionally include optimized data caching, dedicated memory channels, dynamic memory management, and/or enhanced RNG integration.

For example, optimized data caching may include utilizing faster processor caches and refined memory allocation strategies to allow the game controller (e.g., game controller 202) to access and update the persistent symbols data structure almost instantaneously. By avoiding the need to re-calculate or re-fetch the game state and/or other game data from scratch on every spin, processing delays are drastically reduced. For example, memory 208 may be implemented to achieve such tasks, and/or other memories (e.g., local cache memories) may be implemented via game controller 202 and/or processor 204 to realize such gains. This amounts to improvements in optimized data caching, at least due to implementing the specific computing tasks necessary to leverage the random reveal symbols as described herein, where the execution of the random persistent reveal symbols game mechanic differs drastically from conventional sticky mechanics and requires additional design complexity to achieve. For example, conventional persistent symbols may be randomly placed on reel strips and adhere to the reels for a certain number of spins once they appear. However, unlike conventional persistent symbols which replace certain symbol positions on the reel strip, the present disclosure incorporates the use of persistent symbols with other randomly determined and defined symbol positions which all share a common randomly determined, dynamically selected symbol.

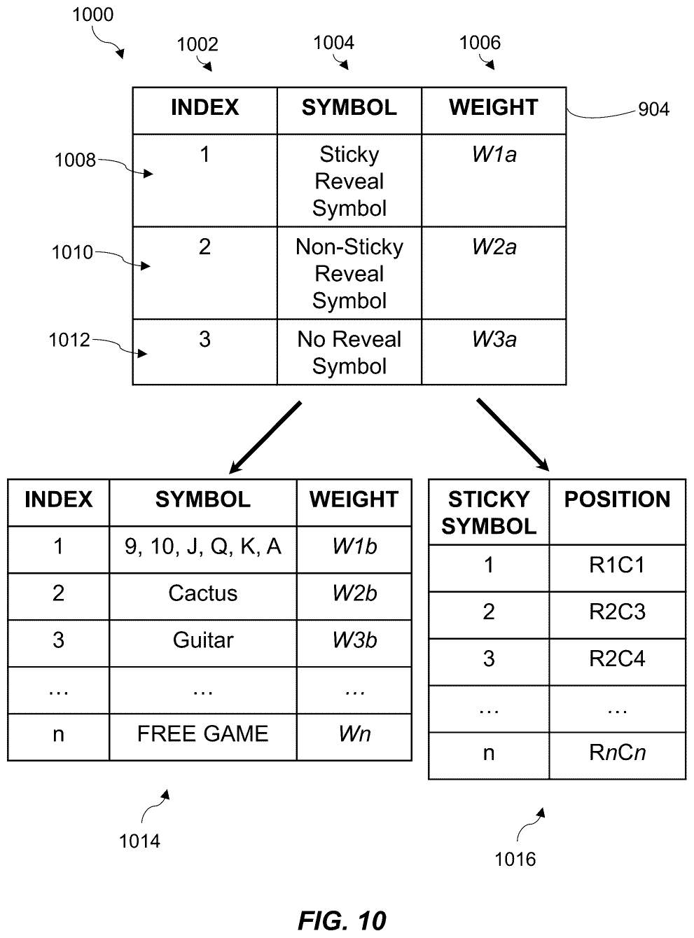

Dedicated memory channels may include specialized hardware (such as GPU processing or FPGA implementations) to handle state-dependent computations, and be implemented to offload tasks such as tracking and/or loading persistent and/or common symbols in memory 208 of game controller 202 and/or other local memories, enabling parallel processing and enhancing overall system responsiveness. For example, for a given free game such as shown in FIGS. 4A/4B, dedicated memory channels may be implemented to update the common symbols (e.g., 438/440) for the free game, as well as to track and manage the random persistent reveal symbols (e.g., 430) (and likewise for the free games shown in FIGS. 5A/5B, and/or 6A/6B). Additionally, or alternatively, dedicated position tracking using position data of the random persistent reveal symbols stored in dedicated memory areas may be utilized to track persistence throughout an entire game session. The dedicated memory for tracking persistence through game sessions may be cleared or reset upon initiation of a new or different game that is separate from the free game session. For example, with reference to FIG. 6B, after free game 10/10 is played, a dedicated memory (e.g., 902) that was used to store position data for random persistent reveal symbols 430/530/630 of the various free games of the overall free game sessions may be cleared. The dedicated memory (e.g., 902) may be used again upon a next free game sessions where one or more random persistent reveal symbols land. The position data of random persistent reveal symbols may be stored in one or more tables the same as or similar to that shown in FIG. 10 (e.g., table 1016). Tables 104 and 1016 may be linked and/or otherwise be utilized in conjunction with configuration 1000 of table 904, or may be configured to be standalone tables that are not directly linked by that may reference one another via various calls to memory and/or other memory associations.

The various dynamic memory management techniques utilized herein may include real-time memory management techniques such as real-time defragmentation to assist in obtaining/maintaining optimal performance. For example, game controller 202 may be implemented to allocate just enough memory to track persistent symbols without the overhead associated with broader game state data, ensuring that even with the added complexity of the random reveal symbols and common symbols described herein, the processing remains efficient and fluid game play and presentation is not negatively impacted. This amounts to improvements in the technology of dynamic memory management, at least due to implementing the specific computing tasks necessary to leverage the random reveal symbols as described herein, where the execution of the random persistent reveal symbols game mechanic differs drastically from conventional persistent mechanics and requires additional design complexity to achieve the various persistence, randomness, and/or dynamic aspects described herein.

Enhanced RNG integration may include precomputing possible outcomes based on a current persistent state and/or faster substitution of symbols, enabling smoother animations and/or more dynamic free game and/or bonus- or feature-triggering mechanisms. For example, with reference to FIG. 4B, common symbol 438 may be the first determined common symbol from an RNG call, where common symbols 440 then need to be resolved to the same symbol. However, the RNG call for symbols 440 may result in a symbol that is not the same as symbol 438—in such case, a dynamic swap of the originally pulled symbols for symbols 440 is performed to ensure that symbols 438 and 440 are all the same when the outcome is displayed, e.g., a “10” symbol as shown in the instance of FIG. 4B. This amounts to improvements in RNG technology, at least due to implementing the specific computing tasks necessary to leverage the random reveal symbols as described herein, where the execution of the random persistent reveal symbols game mechanic differs drastically from conventional persistent mechanics and requires additional design complexity to achieve the various persistence, randomness, and/or dynamic aspects described herein.

In one example, where a random persistent reveal symbols (e.g., 430/530/630) is awarded that will persist on the reels for several spins (e.g., thereby increasing the chances of a big win), a memory such as memory 208 may store an array where each index corresponds to a reel position, and a flag indicates whether that position is occupied by a random persistent reveal symbols (e.g., 430/530/630). When a new spin input is received and a corresponding spin command is generated, game controller 202 may retrieve this array, apply the pre-determined effects of the random persistent reveal symbols (e.g., 430/530/630), and only process the remaining positions via the standard RNG call process described herein. This targeted approach not only accelerates the spin outcome but also minimizes computational loads. This is of great importance in scenarios where multiple simultaneous animations and/or outcomes must be processed in real-time, while also satisfying RTP parameters as described herein.

Leveraging the memory management techniques described herein to track random reveal symbols (both persistent symbols and non-persistent symbols) that reveal a common symbol once activated, shifts from commonplace randomization used in conventional techniques to intelligent state management, where the result is more responsive, accurate, and efficient game mechanics, with corresponding beneficial impacts on gameplay aspects.

By way of the dedicated components (e.g., dedicated memory 902) and/or the customization of game processing architecture 300 via custom tables 904, 1014, and 1016, a game outcome for a respective game instance that includes a plurality of reveal symbols that operate to reveal a single common symbol for the respective game instance is realized in improved fashion compared to conventional techniques such as conventional persistent symbol techniques.

These advanced techniques and processes amount to improvements in the technology of dedicated memory channels, at least due to implementing the specific computing tasks necessary to leverage the random reveal symbols as described herein, where the execution of the random persistent reveal symbols game mechanic differs drastically from conventional persistent mechanics and requires additional design complexity to achieve the various persistence, randomness, and/or dynamic aspects described herein. Without such techniques, it would be inefficient and process intensive to manage the complex and various amounts of tasks associated with implementing a common symbols with two different reveal symbol types as described herein, all the while managing an overall game outcome where certain symbol will persist throughout, but where each game instance may resolve a different respective common symbol. The ability to manage all of the numerous and necessary processing and/or memory tasks so that the various reveal symbols and/or common symbol(s) stay synchronized through a plurality of game instances of an overall game session is a technical improvement to electronic gaming in general and symbol generation and management techniques in particular. The specific implementations described herein are not merely usage of general computing components but rather specific technical implementations of computing components including dedicated computing components.

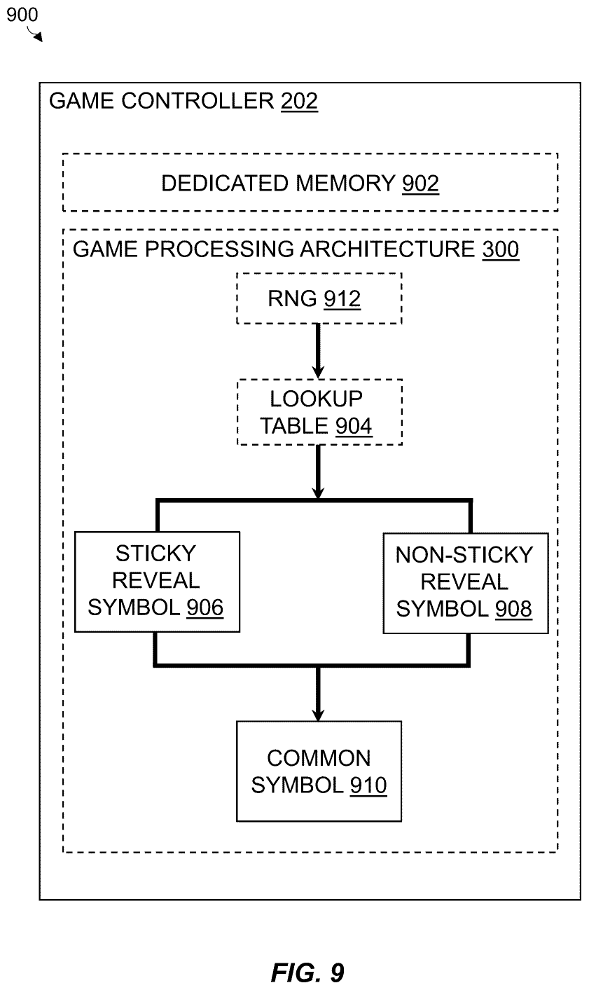

FIG. 9 illustrates, in block diagram form, an implementation of game controller 202 and game processing architecture 300 specifically adapted to execute the dynamic and persistent symbol aspects described herein. More specifically, configuration 900 of game controller 202 may include a dedicated memory 902 which stores one or more dedicated lookup tables 904 as part of game processing architecture 300, where lookup table 904 may be in addition to, or a specialized version of, lookup tables 322A to 322N shown in FIG. 3.

FIG. 2A and/or FIG. 3 may be referenced for comparing the base configurations of game controller 202 and/or game processing architecture 300 to the customizations shown in FIG. 9 for implementing the random sticky or non-sticky reveal symbols and associated common symbol, as well as the persistence aspects of the random persistent reveal symbols, as described herein. For example, dedicated memory 902 may be one or more memories that are part of memory 208 or one or more memories separate from memory 208. In some implementations, dedicated memory 902 may be one or more local cache memories (e.g., L1 cache, L2 cache, etc.) of processor 204. Due to the complexity of managing both the random sticky or non-sticky reveal symbols in connection with the common symbol associated with each, as well as the persistence of the random persistent reveal symbols, instructions and operations relating to such may primarily be stored and performed via dedicated memory 902 to prioritize aspects of the random sticky or non-sticky reveal symbols, such as for faster overall processing to help ensure that the game outcome is finalized and ready for display. For example, game controller 202 may include specialized instructions to perform operations associated with the random sticky or non-sticky reveal symbols at a higher priority level than other symbol operations, and utilize the dedicated components such as dedicated memory 902 and/or dedicated lookup table 904 for such.

Compared to lookup tables 322A-322N shown in FIG. 3, lookup table 904 may be one or more standalone lookup tables specific to the dynamic and/or persistent symbol aspects described herein. For example, lookup table 904 may include one lookup table dedicated to handling the common symbol aspects described herein, and a second lookup table dedicated to handling the persistent symbol aspects described herein. More generally, lookup table 904 may be a dedicated data structure implemented as part of game processing architecture 300 that implements the game processing pipeline for the play of the game in accordance with the various implementations described herein. As described herein, game processing backend system 314 may process RNG calls to generate one or more RNG outcomes, where the RNG outcomes may then be sent to an RNG conversion engine for conversions. This same process may be utilized in connection with the symbol data and/or other data stored in lookup table 904, to generate one or more game outcomes specific to the dynamic and persistent symbol aspects described herein.

In one embodiment, both dedicated memory 902 and dedicated lookup table 904 are implemented and used together specifically for carrying out the dynamic and persistent symbol aspects described herein. In other embodiments, dedicated lookup table 904 may instead be implemented within “standard” memory 208 (e.g., a dedicated memory 902 is not utilized), or dedicated memory 902 may be utilized without a dedicated lookup table 904, where existing lookup tables 322A-332N may be utilized. However, across the various embodiments, due at least to the computing complexity associated with the reveal symbols, at least one of either the dedicated memory 902 or the dedicated lookup table 904 may be utilized to carry out the dynamic and persistent symbols aspects described herein.

In some embodiments, there may be one or more dedicated RNGs 912 specifically utilized for the dynamic and/or persistent symbol aspects described herein, such as a dedicated PRNG as described herein. RNG 912 may include a dedicated RNG conversion engine (not shown) similar to RNG conversion engine 210 or 320 shown in FIGS. 2A and 3, respectively. Accordingly, in some embodiments, the dynamic and/or persistent symbol aspects described herein may be implemented by specifically dedicated hardware and/or software components adapted solely for executing the reveal symbols and/or persistent symbol aspects, including one or all of (i) a dedicated memory (e.g., 902), (ii) a dedicated lookup table (e.g., 904), and/or (iii) a dedicated RNG (e.g., 912). In doing so, the complex processing tasks associ648ated with the reveal and/or persistent symbols described herein are better managed and avoid causing system delays, potential errors, etc., and contribute to improved game mechanics and smoother game play as experienced by a player.

As shown in FIG. 9, an output generated via dedicated memory 902 and/or dedicated lookup table 904 may include a random persistent reveal symbol 906 and a random non-persistent reveal symbol 908. Moreover, the output may include, for each of reveal symbols 906 and 908, a common symbol 910 to be revealed upon operation of reveal symbols 906 and 908. For example, in the case of the green and gold saloon doors shown in FIGS. 4A/4B, 5A/5B, and/or 6A/6B, common symbol 910 is embodied by common symbols 438/440, 540/542, and/or 648/650 that are revealed once the corresponding saloon doors are “opened” to reveal the “underlying” symbol. In the scenarios shown in FIGS. 4A/4B, 5A/5B, and/or 6A/6B, which merely show a few non-limiting examples of common symbol selection: (i) common symbol 910 is embodied by a “10” symbol (FIG. 4B); (ii) common symbol 910 is embodied as a “FREE GAME” symbol (FIG. 5B); and (iii) common symbol 910 is embodied as a “Guitar” symbol (FIG. 6B).

FIG. 10 illustrates an implementation of dedicated lookup table 904, specifically a configuration 1000 of lookup table 904 including indices for a random dynamic persistent reveal symbol (e.g., 906 shown in FIG. 9), a random dynamic non-persistent reveal symbol (e.g., 908 shown in FIG. 9), and a common symbol (e.g., 910 shown in FIG. 9) that is revealed by the random reveal symbols (e.g., 906/908 in FIG. 9). Configuration 1000 of lookup table 904 may include an INDEX column 1002, a SYMBOL column 1004, and a WEIGHT column 1006, where RNG outcomes may be mapped to positions 1008 and 1010 (e.g., index positions). Random persistent reveal symbols 906 may be assigned a weight W1a, whereas random non-persistent reveal symbols may be assigned a weight W2a, with each weight being set according to a desired probability, while also being in accordance with any applicable RTP. For example, and without limitation, weight W1a may be weighted relative to weight W2a such that random persistent reveal symbols 906 occur less frequently than random non-persistent reveal symbols 908 while still satisfying RTP. Additionally, lookup table 904 may include position 1012 (e.g., index position 1012), which may be an index position associated with a range for an RNG output such that neither a random persistent reveal symbol nor a random non-persistent reveal dynamic symbol result (e.g., neither version of a reveal symbol is selected), having a corresponding weight W3a.

Once the random sticky and/or non-sticky reveal symbols are determined, the determination of the common symbol (e.g., 910) associated therewith may be performed via a separate table from lookup table 904, a sub table of lookup table 904, or a plurality of other indices within lookup table 904, for mapping to the various symbols that common symbol 910 may be embodied as, with examples of such symbols being the “10” symbol, the “FREE GAME” symbol, and the “Guitar” symbol, shown in FIGS. 4B, 5B, and 6B, respectively. For simplicity of viewing, FIG. 10 illustrates determining common symbol 910 via another dedicated lookup table 1014, which may generally be formatted the same as or similar to lookup table 904, where lookup table 1014 is utilized to determine which symbol that common symbol 910 will be embodied as. In some implementations, lookup table 1014 may be one or more tables, for example, one table associated with each of the determined random persistent reveal symbols and random non-persistent reveal symbols.

As shown, lookup table 1014 has index entries (e.g., 1 . . . n) for symbols with corresponding weights, such as “9,” “10,” “J,” “Q,”, “K,” and “A” symbols with a weight W1b, a “Cactus” symbol with a weight W2b, a “Guitar” symbol with a weight W3b, and a “FREE GAME” symbol with a weight Wn. For example, a “FREE GAME” symbol with weight Wn may be weighted to occur less frequently than a “9” symbol with a weight W1b while still satisfying RTP. Additionally, “Cactus” symbol with weight W2b may be weighted to occur with the same frequency as “Guitar” symbol with weight W3b (e.g., despite W2b and W3b appearing to be different weights within lookup table 1014, W2b may actually be equal to W3b). Lookup table 1014 for common symbol 910 may be associated with a dedicated RNG or a separate RNG call of another RNG, where RNG outputs (e.g., number outputs from the RNG) are mapped to entries in lookup tables 1014. Alternatively, common symbol 910 may be determined in another fashion, such as via a linkage to the weights utilized in connection with lookup table 904. For example, common symbol 910 may be associated with a weighting scheme that is dependent upon how many random persistent reveal symbols have been determined to land as part of the game outcome, and/or a ratio of the determined persistent to non-persistent reveal symbols or other weighting scheme. In one implementation, if the determined game outcome includes that by the conclusion of the feature game, 10/15 total symbol positions of the reels (e.g., reels 404-412/504-512/604-612) will be occupied by persistent reveal symbols, then the common symbol may be weighted such that a “FREE GAME” symbol has a substantially reduced likelihood to land in the last game instance of the feature game, while maintaining RTP compliance. Accordingly, the common symbol may be weighted in accordance with the persistent reveal symbols. In a ratio-based implementation, if, for example, four total persistent reveal symbols are determined to land compared to a 10 total non-persistent reveal symbols across a feature game session, the likelihood of landing a “FREE GAME” symbol as common symbol 910 may be less than landing a “10” symbol as common symbol 910, while still satisfying RTP.

Part of the memory management aspects described herein may include ensuring that each dynamic common symbol is of the same type, depending on the how the common symbol is determined. For example, after the common symbol 910 is determined for the game outcome, if any subsequent symbol to be revealed in association with either a persistent reveal symbol or a non-persistent reveal symbol does not match the selected common symbol, a dynamic replacement (e.g., swap) is made of the non-matching symbol to the symbol matching the common symbol. For example, it may be the case that the game outcome for a first feature game instance of an overall feature game session includes a “10” symbol being selected, such as in FIG. 4B. The common, randomly determined, dynamically selected “10” symbol must appear to be revealed by the corresponding persistent/non-persistent reveal symbols. If an RNG pull for the given game instance causes any potential symbol from an associated reel strip to land, each symbols that lands that is not the same as the “10” symbol will need to be swapped to a “10” symbol to ensure the common “10” symbol is revealed in each proper location. Thus, any symbol that is to be revealed via subsequent persistent/non-persistent reveal symbols for instances of the feature game session may be dynamically swapped to the determined common symbol, so that upon executing the reveal of all of the persistent/non-persistent reveal symbols for a given game instance, the same common symbol is revealed. This is just one example of ensuring the common symbol is common amongst all persistent/non-persistent reveal symbols. Other implementations may include setting a flag or otherwise tracking in memory the type of the determined common symbol so that every other resolution of the random persistent/non-persistent reveal symbols to reveal the common symbol uses the flag to automatically select the same symbol as the first determined common symbol. Regardless of the particular implementation of how the common symbol is determined and/or populated, these tasks take place amidst the host of other complex concurrent tasks and therefore call for the advanced processing and memory-management techniques described herein.

From a general operational view point, upon receipt of spin input signal corresponding to a spin executed by a player, the RNG (e.g., 212 or 912) generates a random number that is then formatted to fit into the range of indices defined by the lookup table (e.g., 322A-N or 904). The formatted RNG number is mapped to a specific position (e.g., 1008, 1010, 1012, etc.) in the lookup table (e.g., 904). The particular entry at that index determines the symbol (or set of symbols) (e.g., 906, 908, 910) that appears on the corresponding reel.

Dedicated lookup tables 904 and/or 1014 may be structured as an array or list in which each element corresponds to a symbol in weighted fashion. For example, lookup table 904 may not be formatted simply as a one-to-one mapping between index and symbol, a “weight” may be assigned to a given symbol to reflect how often the symbol should appear relative to others. For example, if a non-persistent reveal symbol 908 is meant to be more common than a persistent reveal symbol 906, non-persistent reveal symbol 908 may have a weight W2a to appear in 10 out of 100 entries, whereas persistent reveal symbol 906 may have a weight W1a corresponding to only occupying 2 out of 100 entries. Similarly, with respect to lookup table 1014, the various symbols that common symbol 910 may be embodied as can have varying weights, or certain subsets of symbols may have a same weight.

Thus, when the RNG output is mapped to a table index such as the indices shown in lookup tables 904 and 1014, the probability of selecting any given symbol directly reflects its assigned weight. This approach not only provides for control to adjust both the game's volatility and its payout structure while ensuring that the overall RTP is maintained, but also provides for managing the additional complexity introduced by the combined dynamic persistent/non-persistent reveal symbols and common symbols mechanics described herein.

FIG. 10 also shows table 1016 which may be utilized in association with configuration 1000 of lookup table 904 and configured to store persistent symbol position data for tracking persistent symbols such as random persistent reveal symbols such as random persistent reveal symbols 430/530/630 shown in FIGS. 4A, 5A, and 6A. For example, once a game outcome that includes one or more random persistent reveal symbols is determined, table 1016 may be implemented to store row and column persistence data associated with the determined random persistent reveal symbols. As shown in FIG. 10, table 1016 may include a column labelled STICKY SYMBOL to track the amount of landed random persistent reveal symbols over a free game session. These symbols may be entered in a temporal order, e.g., “1” representing the first random persistent reveal symbol to land in a given free game of an overall free game session, and “n” representing a last random sticky reveal symbol. Table 1016 may include a second column labelled “POSITION” which includes row and column information corresponding to the landed one or more random persistent reveal symbols.

With reference to 3-row, 5-column (e.g., 3×5) reel format shown FIGS. 4A to 6B, for example, for “Sticky Symbol 1” in table 1016, table 1016 may also store position data for a tracked position of row 1, column 1 (e.g., R1C1). Similarly, for (i) “Sticky Symbol 2” in table 1016, table 1016 may also store position data for a tracked position of row 2, column 3 (e.g., R2C3), (ii) “Sticky Symbol 3” in table 1016, table 1016 may also store position data for a tracked position of row 2, column 4 (e.g., R2C4), and (iii) “Sticky Symbol n” in table 1016, table 1016 may also store position data for a tracked position of row n, column n (e.g., RnCn). Table 1016 may be utilized in conjunction with other memory-centric features such as flags and the like, for example to ensure live-managing of the various position data obtained during the course of the various free games of a free game session.

While not shown in FIG. 10, table 1016 may include additional fields/columns for tracking additional data, such as data to track which free game of the overall free game session the various sticky symbols were determined to land in. For example, such other implementations of table 1016 may include a column labelled “FREE GAME #” where an associated cell of table 1016 is used to track data such as “FREE GAME 3” or “FREE GAME 4,” indicating which free game each particular sticky symbol first landed in.

With reference to FIGS. 4A and 6A, table 1016 may therefore be implemented as shown via TABLES 1 and 2 below to include data for tracking random persistent reveal symbols 430/630 in table entries. For example, table 1016 may include the following data and entries for tracking symbols 430 shown in FIG. 4A:

TABLE 1

| STICKY SYMBOL | POSITION | FREE GAME # |
|---|---|---|
| 1 | R1C4 | 3 |
| 2 | R1C5 | 3 |

Further, table 1016 may include the following data and entries for tracking symbols 630 shown in FIG. 6A:

TABLE 2

| STICKY SYMBOL | POSITION | FREE GAME # |
|---|---|---|
| 1 | R1C4 | 3 |
| 2 | R1C5 | 3 |
| 3 | R2C4 | 9 |
| 4 | R3C4 | 9 |

With reference to TABLE 1 above, position R1C4 for Sticky Symbol 1 correlates to position 434 described in connection with FIG. 4A, and position R1C5 for Sticky Symbol 2 correlates to position 436 described in connection with FIG. 4A (e.g., note that positions 536 and 538 shown in FIG. 5A illustrate the persistence of symbols 430, where symbols 530 in FIG. 5A represent persistent symbols 430 carried over from the prior free game, and where position 536 matches position 434 and position 538 matches position 436). Similarly, with reference to TABLE 2 above, position R2C4 for Sticky Symbol 3 correlates to position 642 described in connection with FIG. 6A, and position R3C4 for Sticky Symbol 4 correlates to position 644 described in connection with FIG. 6A. Note that because symbols 430 landed in FREE GAME 3 of 6, TABLE 1 includes a value of “3” being stored in the “FREE GAME #” column, and similarly TABLE 2 includes a value of “9” being stored in the “FREE GAME #” column for symbols 630 that landed in FREE GAME 9 of 10. Further, column 4 (e.g., C4) used in connection with TABLES 1 and 2 correlates with reels 410/610, and column 5 (e.g., C5) correlates with reels 412/612. The use of “1,” “2,” “3,” and “4” in TABLES 1 and 2 above for indicating the various Sticky Symbols is only an example of how symbols 430 and 630 could be labelled/organized within table 1016, and is non-limiting. Additionally, by comparing TABLE 1 to TABLE 2, the expansion of table 1016 across free games is shown, e.g., to accommodate newly determined persistent symbols.

Additional columns may be utilized in table 1016 to indicate other data, such as the total amount of free games that were awarded in a given free game session, which in the case of FIGS. 4A-6B would be 10 total free games. Further additional columns may be implemented to track data for rounds where new persistent symbols do not land. For example, with reference to TABLE 2, various null entries may be utilized to indicate no new persistent symbols but nevertheless keep track of the prior-landed persistent symbols. Thus, in some implementations table 1016 may include entries such as shown in TABLE 3 below:

TABLE 3

| STICKY SYMBOL | POSITION | FREE GAME # |
|---|---|---|
| 1 | R1C4 | 3 |
| 2 | R1C5 | 3 |
| Null (1) | R1C4 | Null (4) |
| Null (2) | R1C5 | Null (4) |
| . . . | . . . | . . . |
| Null (1) | R1C4 | Null (8) |
| Null (2) | R1C5 | Null (8) |
| . . . | . . . | . . . |
| 3 | R2C4 | 9 |
| 4 | R3C4 | 9 |

In TABLE 3, the third and fourth rows may include various null data to indicate no new persistent symbols landing but still tracking prior-landed persistent symbols. For example, “Null(1)” in row 3 may represent an entry for “Sticky Symbol 1,” where position “R1C4” is carried over and the “FREE GAME #” is “Null(4)” indicating the position being carried over to FREE GAME 4. Likewise for row 4 regarding “Sticky Symbol 2” and its position data. Similarly, the sixth and seventh rows of TABLE 3 may include various null data to indicate no new persistent symbols landing but still tracking prior-landed persistent symbols for later free games of the overall free game session. For example, “Null(1)” in row six may represent an entry for “Sticky Symbol 1,” where position “R1C4” is carried over and the “FREE GAME #” is “Null(8)” indicating the position being carried over to FREE GAME 8. Likewise for row 7 regarding “Sticky Symbol 2” and its position data. Similar entries may be utilized for each landed persistent symbols to keep track of the persistent symbols across the free games.

Table 1016 may be implemented as a customized table specifically tailored for the task of tracking and/or managing random persistent reveal symbols and corresponding data (e.g., position data, temporal data, free game data, etc.), and may utilize dedicated memory such as dedicated memory 902. Table 1016 improves persistence tracking across free games of a free game session, helping to ensure the speed and accuracy of tracking and/or recalling the persistent symbols as being persistent in the determined position(s) amidst the various other complex processing tasks taking place during an individual free game and/or across the entire free game sessions which may include a plurality of free games.

At least by virtue of the specialized hardware and/or software configurations shown in and described in connection with FIGS. 9 and 10, the complex synchronization of the common symbol with the persistent and non-persistent reveal symbols is realized. Additionally, at least by virtue of the specialized hardware and/or software configurations shown in and described in connection with FIGS. 9 and 10, the complex management of the persistent reveal symbols across various game instances within a game (e.g., free spins within a free spin game session) is realized. That is, by way of the nuanced data processing and memory management techniques described herein, the various determinations regarding the common symbols and the persistence of the persistent reveal symbols are realized in a manner that is not conventional, not well-understood, and/or not routine.

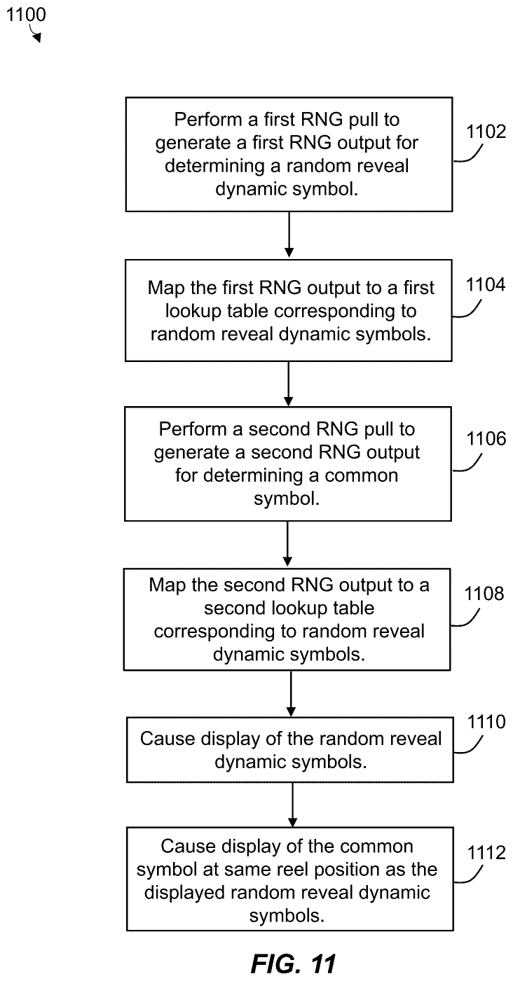

FIG. 11 illustrates an example method 1100 for providing the electronic game shown, where aspects of game processing architecture 300 shown in FIG. 3 have been customized according to configuration 900 shown in FIG. 9 to implement the random persistent/non-persistent and common symbol aspects described herein. Step 1102 includes performing a first RNG call such as via RNG 212 or RNG engine 316 to generate a first RNG output (e.g., random number output) used for determining whether any random sticky or non-sticky reveal symbols will be selected for display as part of a given game play outcome. Step 1104 includes mapping the first RNG output to a first lookup table such as a dedicated lookup table 904 shown in FIG. 9. As described herein, depending upon the ranges and indices associated with the first RNG output, the plurality of symbols for a designated play of an electronic game may include at least one random reveal symbol located at a position on a reel of a reel set which will reveal the associated dynamically selected common symbol (e.g., symbols 438/440, 540/542, 648/650). Step 1106 includes performing a second RNG call to generate a second RNG output used for determining the dynamically selected symbol. Step 1108 includes mapping the second RNG output to a second lookup table such as a dedicated lookup table 1014 shown in FIG. 10. As described herein, the common symbol (e.g., 901) is selected based upon the ranges and indices associated with the second RNG output. Step 1110 includes causing display of the at least one random reveal symbol such as shown in FIGS. 4A/5A/6A. Step 1112 includes causing display of the dynamically selected symbol at a same position as the position of the at least one random reveal symbol, such as shown in FIGS. 4B/5B/6B.

At least the dynamic mapping and memory management aspects described herein accommodate the implementation special features such as being able to better manage persistent symbols across spins while also managing the linking of a common symbol to two different reveal symbols (e.g., the sticky (persistent) and non-sticky (non-persistent) reveal symbols)—these are complex computing tasks compared to conventional symbol generation and require specialized technical techniques including specialized processing, specialized memory usage/allocation, specialized data structure construction, and/or specialized weighting techniques.

The nuanced and deliberate construction of dedicated lookup tables, and the nuanced and deliberate memory configurations and/or settings described herein, each represent technical improvements in the field of electronic gaming on their own accord, and when combined, represent a significant technical improvement that is unconventional, not well-understood, and not routine.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for electronic gaming comprising:
at least one memory device storing instructions and one or more lookup tables storing symbol data therein; and
at least one processor in communication with the at least one memory device, wherein the instructions, when executed by the at least one processor, cause the at least one processor to:
perform a first lookup in the one or more lookup tables to determine a plurality of symbols for a designated play of an electronic game, the plurality of symbols including at least one reveal symbol located at a position on a reel of a reel set of the designated play of the electronic game;
perform a second lookup in the one or more lookup tables to determine a common symbol for association with the at least one reveal symbol, the common symbol being a dynamically selected symbol from a set of the plurality of symbols excluding the at least one reveal symbol;
cause display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol; and
depending on a symbol type of the at least one reveal symbol, cause display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

2. The system according to claim 1, wherein the symbol type of the at least one reveal symbol includes (i) a random non-persistent reveal symbol or (ii) a random persistent reveal symbol.

3. The system according to claim 2, wherein the at least one random reveal symbol is at least one random persistent reveal symbol, and the display of the subsequent at least one random reveal symbol at the position on the reel of the reel set of the subsequent play of the electronic game includes display of the at least one random persistent reveal symbol.

4. The system according to claim 1, wherein the symbol type of the at least one reveal symbol includes at least one random persistent reveal symbol, wherein the at least one memory device includes a dedicated memory device customized for storing data associated with the at least one random persistent reveal symbol, and the instructions, when executed by the at least one processor, further cause the at least one processor to:
track, in the dedicated memory device, position data corresponding to the at least one random persistent reveal symbol.

5. The system according to claim 4, wherein the instructions, when executed by the at least one processor, further cause the at least one processor to:
determine a symbol type of the common symbol based at least upon a weight associated with the at least one persistent reveal symbol.

6. The system according to claim 1, wherein the designated play of the electronic game is one play of a plurality of plays of a feature game of the electronic game, and wherein at least one reveal symbol includes, for an entire play of the feature game, (i) a plurality of random non-persistent reveal symbols and (ii) a plurality of random persistent reveal symbols.

7. The system according to claim 6, wherein the display of the common symbol includes display of the common symbol at each respective position of each of (i) the plurality of random non-persistent reveal symbols and (ii) the plurality of random persistent reveal symbols.

8. The system according to claim 6, wherein the instructions, when executed, further cause the at least one processor to:
synchronize the common symbol for each of (i) the plurality of random non-persistent reveal symbols and (ii) the plurality of random persistent reveal symbols.

9. The system according to claim 6, wherein the one or more lookup tables includes (i) a first lookup table storing symbol data corresponding to the plurality of random non-persistent reveal symbols and the plurality of random persistent reveal symbols, and (ii) a second lookup table storing symbol data corresponding to the common symbol.

10. The system according to claim 1, wherein the one or more lookup tables includes a first lookup table and a second lookup table, wherein the first lookup table is a dedicated weighted table including one or more weights associated with the at least one reveal symbol, and wherein the second lookup is a lookup in the second lookup table, and the instructions, when executed, further cause the at least one processor to:
determine the common symbol based at least upon the one or more weights.

11. The system according to claim 1, wherein the designated play and the subsequent play occur within a same session of play, the subsequent play being after the designated play.

12. A computer-implemented method for electronic gaming, the computer-implemented method being performed by a system comprising at least one memory device storing instructions and one or more lookup tables storing symbol data therein and at least one processor in communication with the at least one memory device, the computer-implemented method comprising:
performing a first lookup in the one or more lookup tables to determine a plurality of symbols for a designated play of an electronic game, the plurality of symbols including at least one reveal symbol located at a position on a reel of a reel set of the designated play of the electronic game;
performing a second lookup in the one or more lookup tables to determine a common symbol for association with the at least one reveal symbol, the common symbol being a dynamically selected symbol from a set of the plurality of symbols excluding the at least one reveal symbol;
causing display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol; and
depending on a symbol type of the at least one reveal symbol, causing display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

13. The computer-implemented method according to claim 12, wherein the symbol type of the at least one reveal symbol includes at least one random persistent reveal symbol, wherein the at least one memory device includes a dedicated memory device customized for storing data associated with the at least one random persistent reveal symbol, and the computer-implemented method further comprises:
tracking, in the dedicated memory device, position data corresponding to the at least one random persistent reveal symbol.

14. The computer-implemented method according to claim 12, wherein the designated play of the electronic game is one play of a plurality of plays of a feature game of the electronic game, and wherein at least one reveal symbol includes, for an entire play of the feature game, (i) a plurality of random non-persistent reveal symbols and (ii) a plurality of random persistent reveal symbols.

15. The computer-implemented method according to claim 14, wherein the display of the common symbol includes display of the common symbol at each respective position of each of (i) the plurality of random non-persistent reveal symbols and (ii) the plurality of random persistent reveal symbols, and the computer-implemented method further comprises:
synchronizing the common symbol for each of (i) the plurality of random non-persistent reveal symbols and (ii) the plurality of random persistent reveal symbols.

16. The computer-implemented method according to claim 12, wherein the one or more lookup tables includes a first lookup table and a second lookup table, wherein the first lookup table is a dedicated weighted table including one or more weights associated with the at least one reveal symbol, and wherein the second lookup is a lookup in the second lookup table, and the computer-implemented further comprises:
determining the common symbol based at least upon the one or more weights.

17. At least one non-transitory computer-readable media having computer-executable instructions stored thereon for electronic gaming, wherein when executed by a system comprising at least one memory device storing instructions and one or more lookup tables storing symbol data therein and at least one processor in communication with the at least one memory device, the computer-executable instructions cause the at least one processor to:
perform a first lookup in the one or more lookup tables to determine a plurality of symbols for a designated play of an electronic game, the plurality of symbols including at least one reveal symbol located at a position on a reel of a reel set of the designated play of the electronic game;
perform a second lookup in the one or more lookup tables to determine a common symbol for association with the at least one reveal symbol, the common symbol being a dynamically selected symbol from a set of the plurality of symbols excluding the at least one reveal symbol;
cause display of (i) the plurality of symbols including the at least one reveal symbol for the designated play of the electronic game followed by (ii) the common symbol, at a same position as the position of the at least one reveal symbol, wherein the display of the at least one reveal symbol is ceased upon the display of the dynamically selected symbol; and
depending on a symbol type of the at least one reveal symbol, cause display of a subsequent at least one reveal symbol at a position on a reel of a reel set of a subsequent play of the electronic game, the position on the reel of the reel set of the subsequent play of the electronic game being the same as the position on the reel of the reel set of the designated play of the electronic game.

18. The at least one non-transitory computer-readable media according to claim 17, wherein the symbol type of the at least one reveal symbol includes at least one random persistent reveal symbol, wherein the at least one memory device includes a dedicated memory device customized for storing data associated with the at least one random persistent reveal symbol, and the computer-executable instructions, when executed, further cause the at least one processor to:
track, in the dedicated memory device, position data corresponding to the at least one random persistent reveal symbol.

19. The at least one non-transitory computer-readable media according to claim 17, wherein the designated play of the electronic game is one play of a plurality of plays of a feature game of the electronic game, wherein at least one reveal symbol includes, for an entire play of the feature game, (i) a plurality of random non-persistent reveal symbols and (ii) a plurality of random persistent reveal symbols, and wherein the computer-executable instructions, when executed, further cause the at least one processor to:
synchronize the common symbol for each of (i) the plurality of random non-persistent reveal symbols and (ii) the plurality of random persistent reveal symbols.

20. The at least one non-transitory computer-readable media according to claim 19, wherein the one or more lookup tables includes a first lookup table and a second lookup table, wherein the first lookup table is a dedicated weighted table including one or more weights associated with the at least one reveal symbol, wherein the second lookup is a lookup in the second lookup table, and wherein the computer-executable instructions, when executed, further cause the at least one processor to:
determine the common symbol based at least upon the one or more weights.
